(19) United States
(12) Patent Application Publication
(10) Pub. No.: US 2009/0030099 A1
(43) Pub. Date: Jan. 29, 2009

(54) FOAM COMPOSITION AND FOAM

(75) Inventors: Keisuke Chino, Kanagawa (JP); Tomoyuki Sakai, Kanagawa (JP)

Correspondence Address: CONNOLLY BOVE LODGE & HUTZ LLP, 1875 EYE STREET, N.W., SUITE 1100, WASHINGTON, DC, 20006, US

(73) Assignee: The Yokohama Rubber Co., Ltd., Tokyo (JP)

(21) Appl. No.: 11/816,881

(22) PCT Filed: Feb. 21, 2006
(86) PCT No.: PCT/JP2006/303028

§ 371 Date: Aug. 22, 2007

(30) Foreign Application Priority Data
Feb. 24, 2005 (JP) 2005-048833

(51) Int. Cl. C08J 9/04; C08L 25/04

(52) U.S. Cl. 521/139; 521/134; 521/50

(57) ABSTRACT

An object of the present invention is to provide a foam having reduced hardness and density, and an improved resistance to compression set, as well as a foam composition for producing such a foam. This object is achieved by a foam composition described below. The foam composition of the present invention comprises a thermoplastic elastomer which has a side chain containing imino group and/or a nitrogen-containing heterocycle, and a carbonyl-containing group; and a blowing agent.

### TECHNICAL FIELD

This invention relates to a foam composition and a foam, and more particularly, to a foam composition containing a thermoplastic elastomer which has the characteristic of repeatedly and reproducibly undergoing crosslinking and de-crosslinking by temperature change (hereinafter sometimes referred to as “recyclability”).

### BACKGROUND ART

Recycling of once used materials is an urgent agenda in these days for environmental protection, resources saving, and other considerations. A crosslinked rubber (vulcanized rubber) has a stable three-dimensional network structure formed by covalent bonding of a macromolecular substance and a crosslinking agent (vulcanizing agent), and accordingly exhibits very high strength. Re-molding of such material, however, is difficult due to the crosslinking by the strong covalent bonding. On the other hand, thermoplastic elastomers utilize physical crosslinking, and molding of such material is readily accomplished by heat melting the material without the necessity of complicated vulcanization and molding steps including preforming.

A typical known example of such thermoplastic elastomer is a thermoplastic elastomer which contains a resin component and a rubber component, and in which the microcrystalline resin component constitutes a hard segment acting as the crosslink moiety for the three-dimensional network structure thereby preventing plastic deformation of the rubber component (soft segment) at room temperature, and softens or melts at an elevated temperature thus causing plastic deformation of the elastomer. Such thermoplastic elastomer containing the resin component, however, often suffers from the loss of rubber elasticity, and therefore, a material which is free from such resin component and to which thermoplasticity can be imparted is highly demanded.

In view of such situation, the inventors of the present invention have already found that a thermoplastic elastomer which is crosslinkable by hydrogen bond and which includes an elastomeric polymer having a carbonyl-containing group and a heterocyclic amine-containing group in its side chain can repetitively undergo crosslinking and de-crosslinking by changing temperature through the use of the hydrogen bond. Based on such finding, the inventors proposed a thermoplastic elastomer which is crosslinkable by hydrogen bond and which includes an elastomeric polymer having (i) a carbonyl-containing group and (ii) a heterocyclic amine-containing group in its side chain; and a method for the production of such thermoplastic elastomer which involves reacting an elastomeric polymer having a cyclic acid anhydride group in its side chain and a heterocyclic amine-containing compound at a temperature allowing the heterocyclic amine-containing compound to be chemically bonded to the cyclic acid anhydride group to thereby produce the thermoplastic elastomer (see, for example, Patent Document 1).

The thermoplastic elastomer having such properties has enormous industrial and environmental values, and such material is also expected as a material having higher strength after crosslinking and excellent recyclability without change in its physical properties even after repetitive crosslinking and de-crosslinking.

### Patent Document 1: JP 2000-169527 A

### DISCLOSURE OF THE INVENTION

### Problems to be Solved by the Invention

However, even the thermoplastic elastomer described in Patent Document 1 as referred to above suffered from excessively high hardness and density, and hence, increased weight and specific gravity when it was used as a composition after blending it with a filler and the like. Also, such composition was occasionally insufficient in its resistance to compression set when it was compressed for a certain time and released from the compression, and use of the composition for foam applications such as cap and packing materials has been difficult.

Accordingly, an object of the present invention is to provide a foam having reduced hardness and density as well as improved resistance to compression set, and a foam composition for producing such a foam.

### Means to Solve the Problems

In view of the situation as described above, the inventors of the present invention have made an intensive investigation to overcome the problems as described above and found that a foam produced from a foam composition containing a thermoplastic elastomer having a side chain of predetermined structure and a blowing agent exhibits reduced hardness and density with improved resistance to compression set, and the present invention has been completed on the basis of such a finding. Accordingly, the present invention provides the foam composition and the foam as described in the (I) to (XXX), below.

(I) A foam composition comprising: a thermoplastic elastomer (A) which has a side chain containing at least one member selected from the group consisting of imino group, nitrogen-containing heterocycle and covalent crosslink site, and a carbonyl-containing group; and a blowing agent (D).
(II) A foam composition comprising: a thermoplastic elastomer composition comprising a thermoplastic elastomer (A) which has a side chain containing at least one member selected from the group consisting of imino group, nitrogen-containing heterocycle and covalent crosslink site, and a carbonyl-containing group; a thermoplastic polymer (B) and an internal release agent (C); and a blowing agent (D).
(III) The foam composition according to (II) above wherein the thermoplastic polymer (B) has an MFR (melt mass-flow rate) of at least 0.01 g/10 min as measured at 230° C. under the load of 2.16 kg.
(IV) The foam composition according to (II) or (III) above wherein content of the thermoplastic polymer (B) is 1 to 300 parts by weight in relation to 100 parts by weight of the thermoplastic elastomer (A).
(V) The foam composition according to any one of (II) to (IV) above wherein the thermoplastic elastomer (A) and the thermoplastic polymer (B) have a solubility parameter (Sp) value satisfying the formula:

$$0.9 < \frac{S p ( A )}{S p ( B )} < 1.1 \qquad [ Mathematical Formula 1 ]$$

wherein Sp(A) represents the solubility parameter of the thermoplastic elastomer (A) and Sp(B) represents the solubility parameter of the thermoplastic polymer (B).
(VI) The foam composition according to any one of (II) to (V) above wherein the internal release agent (C) is at least one member selected from the group consisting of fatty acid amide, fatty acid ester, fatty acid metal salt, and metallic compound.
(VII) The foam composition according to any one of (II) to (VI) above wherein content of the internal release agent (C) is 0.1 to 50 parts by weight in relation to 100 parts by weight of the thermoplastic elastomer (A).
(VIII) The foam composition according to any one of (II) to (VII) above wherein the thermoplastic elastomer composition has a capillary viscosity of at least 3000 Pa·s as measured at 120° C. and at a shear rate 60.8 s⁻¹.

The side chain of the thermoplastic elastomer (A) contains preferably imino group and/or a nitrogen-containing heterocycle, and a carbonyl-containing group, more preferably imino group and a carbonyl-containing group, and still more preferably imino group, a nitrogen-containing heterocycle, and a carbonyl-containing group.

(IX) The foam composition according to any one of (I) to (VIII) above wherein the side chain of the thermoplastic elastomer (A) contains a structure represented by the following formula (1):

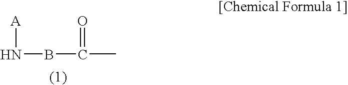

wherein A is an alkyl group containing 1 to 30 carbon atoms, an aralkyl group containing 7 to 20 carbon atoms, or an aryl group containing 6 to 20 carbon atoms; B is a single bond; oxygen atom, an amino group NR′ (wherein R′ is hydrogen atom or an alkyl group containing 1 to 10 carbon atoms), or sulfur atom; or an organic group which may contain such atom or group.
(X) The foam composition according to (IX) above wherein the side chain containing the structure represented by the formula (1) contains a structure represented by the following formula (2) or (3) which binds to a main chain at α position or β position:

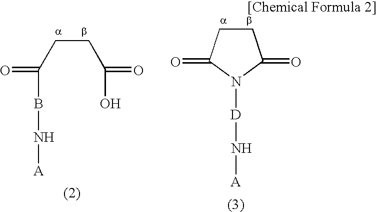

wherein A is an alkyl group containing 1 to 30 carbon atoms, an aralkyl group containing 7 to 20 carbon atoms, or an aryl group containing 6 to 20 carbon atoms, B and D are independently a single bond; oxygen atom, an amino group NR′ (wherein R′ is hydrogen atom or an alkyl group containing 1 to 10 carbon atoms), or sulfur atom; or an organic group which may contain such atom or group.
(XI) The foam composition according to any one of (I) to (VIII) above wherein the side chain of the thermoplastic elastomer (A) contains a structure represented by the following formula (4):

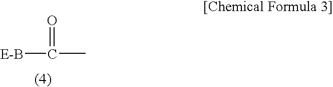

wherein E is a nitrogen-containing heterocycle, and B is a single bond; oxygen atom, an amino group NR′ (wherein R′ is hydrogen atom or an alkyl group containing 1 to 10 carbon atoms), or sulfur atom; or an organic group which may contain such atom or group.
(XII) The foam composition according to (XI) above wherein the side chain containing the structure represented by the formula (4) contains a structure represented by the following formula (5) or (6) which binds to a main chain at α position or β position:

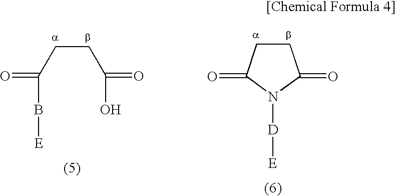

wherein E is a nitrogen-containing heterocycle, and B and D are independently a single bond; oxygen atom, an amino group NR′ (wherein R′ is hydrogen atom or an alkyl group containing 1 to 10 carbon atoms), or sulfur atom; or an organic group which may contain such atom or group.
(XIII) The foam composition according to any one of (I) to (VIII), (XI) and (XII) above wherein the nitrogen-containing heterocycle is a five-membered or a six-membered ring.
(XIV) The foam composition according to (XIII) above wherein the nitrogen-containing heterocycle is triazole ring, thiadiazole ring, pyridine ring, thiazole ring, imidazole ring, or hydantoin ring.
(XV) The foam composition according to (XI) above wherein the side chain containing the structure represented by the formula (4) contains a structure represented by the following formula (7), formula (8) or (9), or formula (10):

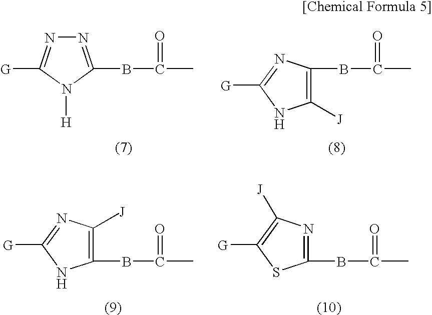

wherein B is a single bond; oxygen atom, an amino group NR′ (wherein R′ is hydrogen atom or an alkyl group containing 1 to 10 carbon atoms), or sulfur atom; or an organic group which may contain such atom or group, and G and J are independently hydrogen atom, an alkyl group containing 1 to carbon atoms, an aralkyl group containing 7 to 20 carbon atoms, or an aryl group containing 6 to 20 carbon atoms.
(XVI) The foam composition according to (XV) above wherein the side chain containing the structure represented by the formula (4) contains a structure which binds to a main chain at α position or β position and is represented by the following formula (11) or (12), any one of formulae (13) to (16), or formula (17) or (18):

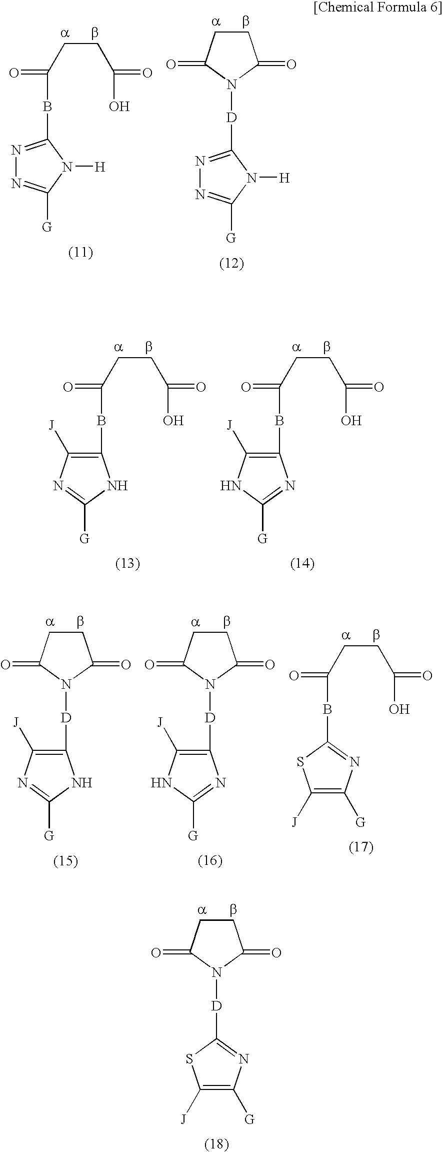

wherein B and D are independently a single bond; oxygen atom, an amino group NR′ (wherein R′ is hydrogen atom or an alkyl group containing 1 to 10 carbon atoms), or sulfur atom; or an organic group which may contain such atom or group, G and J are independently hydrogen atom, an alkyl group containing 1 to 30 carbon atoms, an aralkyl group containing 7 to 20 carbon atoms, or an aryl group containing 6 to 20 carbon atoms.
(XVII) The foam composition according to any one of (I) to (XVI) above wherein crosslink at the covalent crosslink site can be realized by at least one bond selected from the group consisting of amide, ester, lactone, urethane, ether, thiourethane, and thioether.
(XVIII) The foam composition according to any one of (I) to (XVI) above wherein crosslink at the covalent crosslink site has been realized by at least one bond selected from the group consisting of amide, ester, lactone, urethane, ether, thiourethane, and thioether.
(XIX) The foam composition according to (XVIII) above wherein the covalent crosslink site contains a tertiary amino group.
(XX) The foam composition according to (XVIII) or (XIX) above wherein the covalent crosslink site contains at least one structure represented by any one of the following formulae (19) to (21):

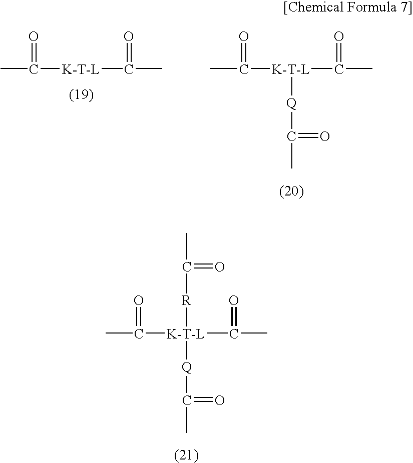

wherein K, L, Q, and R are independently a single bond; oxygen atom, an amino group NR′ (wherein R′ is hydrogen atom or an alkyl group containing 1 to 10 carbon atoms), or sulfur atom; or an organic group which may contain such atom or group, and T is an optionally branched hydrocarbon group which may contain oxygen atom, sulfur atom, or nitrogen atom.
(XXI) The foam composition according to (XX) above wherein the covalent crosslink site contains at least one structure represented by any one of the following formulae (22) to (24) which binds to a main chain at α position or β position:

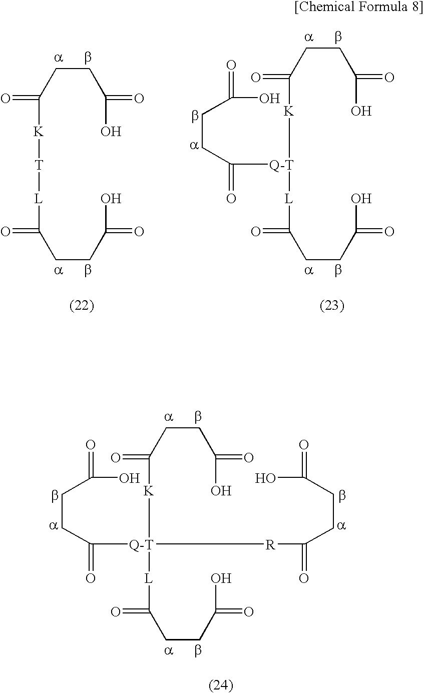

wherein K, L, Q, and R are independently a single bond; oxygen atom, an amino group NR′ (wherein R′ is hydrogen atom or an alkyl group containing 1 to 10 carbon atoms), or sulfur atom; or an organic group which may contain such atom or group, and T is an optionally branched hydrocarbon group which may contain oxygen atom, sulfur atom, or nitrogen atom.
(XXII) The foam composition according to (XX) or (XXI) above wherein any T in the formulae (19) to (24) contains a tertiary amino group.
(XXIII) The foam composition according to any one of (XVIII) to (XXII) above wherein the covalent crosslink site is formed by a reaction of a cyclic acid anhydride group with hydroxy group, an amino group and/or imino group.
(XXIV) The foam composition according to any one of (I) to (XXIII) above wherein content of the foam is 0.01 to 10% by weight in relation to a total weight of the foam composition.
(XXV) The foam composition according to any one of (I) to (XXIV) above which is capable of being kneaded at a temperature of not higher than 180° C.
(XXVI) The foam composition according to any one of (I) to (XXV) above further comprising a styrene thermoplastic elastomer.
(XXVII) The foam composition according to (XXVI) above wherein content of the styrene thermoplastic elastomer is 1 to 500 parts by weight in relation to 100 parts by weight of the thermoplastic elastomer (A).
(XXVIII) The foam composition according to any one of (I) to (XXVII) above further comprising a filler.
(XXIX) The foam composition according to (XXVIII) above wherein content of the filler is 1 to 200 parts by weight in relation to 100 parts by weight of the thermoplastic elastomer (A).
(XXX) A foam obtained by blowing the foam composition according to any one of (I) to (XXIX) above.

### EFFECTS OF THE INVENTION

As will be described below, the present invention is quite useful since it can provide a foam having reduced hardness and density as well as improved resistance to compression set, and a foam composition for producing such a foam.

### BEST MODE FOR CARRYING OUT THE INVENTION

Next, the present invention is described in further detail.

The foam composition according to a first aspect of the present invention is a foam composition comprising a thermoplastic elastomer (A) which has a side chain containing at least one member selected from the group consisting of imino group, nitrogen-containing heterocycle and covalent crosslink site, and a carbonyl-containing group; and a blowing agent (D).

The foam composition according to a second aspect of the present invention is a foam composition comprising a thermoplastic elastomer composition including a thermoplastic elastomer (A) which has a side chain containing at least one member selected from the group consisting of imino group, nitrogen-containing heterocycle and covalent crosslink site, and a carbonyl-containing group; a thermoplastic polymer (B); and an internal release agent (C); as well as a blowing agent (D).

Next the thermoplastic elastomer (A), the thermoplastic polymer (B), the internal release agent (C), and the blowing agent (D) used in the foam composition according to the first and the second aspect of the present invention (hereinafter sometimes simply referred to as “the foam composition of the present invention”) are described in detail.

<Thermoplastic Elastomer (A)>

The thermoplastic elastomer (A) used in the foam composition of the present invention is a natural or synthetic elastomeric polymer having a side chain containing at least one member selected from the group consisting of imino group, nitrogen-containing heterocyclic group, and covalent crosslink site; and a carbonyl-containing group.

In the present invention, the term “side chain” means a side chain or a terminal of an elastomeric polymer, and “having a side chain containing at least one member selected from the group consisting of imino group, nitrogen-containing heterocycle, and covalent crosslink site; and a carbonyl-containing group” means that at least one member selected from the group consisting of imino group, nitrogen-containing heterocycle, and covalent crosslink site; as well as a carbonyl-containing group are attached to the atom (which is typically carbon atom) constituting the main chain of the elastomeric polymer by a chemically stable bond (for example, a covalent bond or an ionic bond).

The elastomeric polymer constituting the main chain of the thermoplastic elastomer (A) is not particularly limited as long as it is a commonly known natural or synthetic polymer whose glass transition point is not higher than room temperature (25° C.).

Examples of such elastomeric polymer include diene rubbers such as natural rubber (NR), isoprene rubber (IR), butadiene rubber (BR), 1,2-butadiene rubber, styrene-butadiene rubber (SBR), acrylonitrile-butadiene rubber (NBR), chloroprene rubber (CR), butyl rubber (IIR), and ethylene-propylene-diene rubber (EPDM) and their hydrogenated products; olefin rubbers such as ethylene-propylene rubber (EPM), ethylene-acrylic rubber (AEM), ethylene-butene rubber (EBM), chlorosulfonated polyethylene, acrylic rubber, fluororubber, polyethylene rubber, and polypropylene rubber; epichlorohydrin rubber; polysulfide rubber; silicone rubber; and urethane rubber.

Alternatively, the elastomeric polymer may be an elastomeric polymer containing a resin component, and examples of the elastomeric polymer include optionally hydrogenated polystyrene elastomeric polymers (for example, SBS, SIS, and SEBS), polyolefin elastomeric polymers, polyvinyl chloride elastomeric polymers, polyurethane elastomeric polymers, polyester elastomeric polymers, and polyamide elastomeric polymers.

The elastomeric polymer as described above may be a liquid or a solid polymer having a non-limited molecular weight, and the elastomeric polymer may be adequately selected depending on the application, the physical properties required, and other factors of the foam composition of the present invention and a foam according to a third aspect of the present invention (which is hereinafter simply referred to as “the foam of the present invention”).

When weight is given to fluidity of the foam composition of the present invention and the foam of the present invention (which may be sometimes together referred to as “the foam (composition) of the present invention”) after their heating (de-crosslinking), the elastomeric polymer is preferably liquid, and for example, in the case of a diene rubber such as isoprene rubber or butadiene rubber, such diene rubber may preferably have a weight average molecular weight in the range of 1,000 to 100,000, and more preferably, about 1,000 to 50,000.

On the other hand, when weight is given to strength of the foam (composition) of the present invention, the elastomeric polymer is preferably solid, and for example, in the case of a diene rubber such as isoprene rubber or butadiene rubber, such diene rubber may preferably have a weight average molecular weight of at least 100,000, and more preferably, about 500,000 to 1,500,000.

In the present invention, the weight average molecular weight is a weight average molecular weight (calculated in terms of polystyrene) determined by gel permeation chromatography (GPC), which is preferably conduced by using tetrahydrofuran (THF) for the solvent.

In the present invention, the elastomeric polymers as described above may be used as a mixture of two or more. In such a case, the elastomeric polymers may be mixed at any ratio depending on the application of the foam (composition) of the present invention and the physical properties and other factors required for the foam (composition) of the present invention.

As described above, the elastomeric polymer may preferably have a glass transition point of not higher than 25° C., and when the elastomeric polymer has two or more glass transition points or when two or more elastomeric polymers are used as a mixture, at least one of the glass transition points is preferably not higher than 25° C. The elastomeric polymer preferably has such glass transition point since the article molded from the foam (composition) of the present invention then exhibits rubber elasticity at room temperature.

In the present invention, the glass transition point is the one measured by differential scanning calorimetry (DSC), which is preferably carried out at a temperature elevation rate of 10° C./min.

Such elastomeric polymer is preferably a diene rubber such as natural rubber (NR), isoprene rubber (IR), butadiene rubber (BR), 1,2-butadiene rubber, styrene-butadiene rubber (SBR), ethylene-propylene-diene rubber (EPDM), or butyl rubber (IIR); or an olefin rubber such as ethylene-propylene rubber (EPM), ethylene-acrylic rubber (AEM), or ethylene-butene rubber (EBM) in view of the glass transition point of the rubber which is not higher than 25° C., and the rubber elasticity at room temperature of the article molded from the foam (composition) of the present invention. In addition, when the elastomeric polymer used is an olefin rubber, the resulting foam (composition) of the present invention will exhibit an improved tensile strength after crosslinking, and also, deterioration of the composition will be suppressed due to the absence of the double bond.

In the present invention, the amount of styrene bonded in the case of styrene-butadiene rubber (SBR), or the degree of hydrogenation in the case of a hydrogenated elastomeric polymer is not particularly limited, and such amount or degree may be adjusted to any level depending on the application of the foam (composition) of the present invention and the physical properties and other factors required for the foam (composition) of the present invention.

When an ethylene-propylene-diene rubber (EPDM), an ethylene-acrylic rubber (AEM), an ethylene-propylene rubber (EPM), or an ethylene-butene rubber (EBM) is used for the main chain of the elastomeric polymer, the ethylene content is preferably in the range of 10 to 90% by mole, and more preferably 40 to 90% by mole. When the ethylene content is within such range, the resulting foam (composition) will exhibit improved resistance to compression set as well as excellent mechanical strength.

The thermoplastic elastomer (A) used in the foam composition of the present invention is the elastomeric polymer as described above having a side chain containing at least one member selected from the group consisting of imino group, nitrogen-containing heterocycle, and covalent crosslink site; and a carbonyl-containing group. Preferably, the side chain contains imino group and/or a nitrogen-containing heterocycle together with a carbonyl-containing group, and more preferably the side chain contains imino group and a carbonyl-containing group, and still more preferably, the side chain contains imino group, a nitrogen-containing heterocycle, and a carbonyl-containing group.

In the present invention, when the side chain contains imino group and a carbonyl-containing group, the side chain may preferably have a structure represented by the following formula (1):

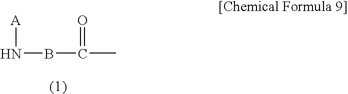

wherein A is an alkyl group containing 1 to 30 carbon atoms, an aralkyl group containing 7 to 20 carbon atoms, or an aryl group containing 6 to 20 carbon atoms; B is a single bond; oxygen atom, an amino group NR′ (wherein R′ is hydrogen atom or an alkyl group containing 1 to 10 carbon atoms), or sulfur atom; or an organic group which may contain such atom or group.

The substituent A is not particularly limited as long as it is an alkyl group containing 1 to 30 carbon atoms, an aralkyl group containing 7 to 20 carbon atoms, or an aryl group containing 6 to 20 carbon atoms.

Examples of such substituent A include straight chain alkyl groups such as methyl group, ethyl group, propyl group, butyl group, pentyl group, octyl group, dodecyl group, and stearyl group; branched alkyl groups such as isopropyl group, isobutyl group, s-butyl group, t-butyl group, isopentyl group, neopentyl group, t-pentyl group, 1-methylbutyl group, 1-methylheptyl group, and 2-ethylhexyl group; aralkyl groups such as benzyl group and phenethyl group; and aryl groups such as phenyl group, tolyl group (o-, m-, p-), dimethylphenyl group, and mesityl group.

Among these, the preferred are alkyl groups, and in particular, butyl group, octyl group, dodecyl group, isopropyl group, and 2-ethylhexyl group in view of the improved workability of the resulting foam (composition) of the present invention.

The substituent B is not particularly limited as long as it is a single bond; oxygen atom, an amino group NR′ (wherein R′ is hydrogen atom or an alkyl group containing 1 to 10 carbon atoms), or sulfur atom; or an organic group which may contain such atom or group.

For example, the substituent B may be a single bond; oxygen atom, sulfur atom, or an amino group NR′ (wherein R′ is hydrogen atom or an alkyl group containing 1 to 10 carbon atoms); an alkylene group or an aralkylene group containing 1 to 20 carbon atoms which may contain such atom or group; an alkylene ether group (an alkyleneoxy group, for example, —O—CH₂CH₂— group), an alkyleneamino group (for example, —NH—CH₂CH₂— group), or an alkylene thioether group (an alkylenethio group, for example, —S—CH₂CH₂— group) containing 1 to 20 carbon atoms which has such atom or group at its terminal; or an aralkylene ether group (aralkyleneoxy group), an aralkyleneamino group, or an aralkylene thioether group containing 1 to 20 carbon atoms which has such atom or group at its terminal.

In the amino group NR′, examples of the alkyl group containing 1 to 10 carbon atoms include methyl group, ethyl group, propyl group, butyl group, pentyl group, hexyl group, heptyl group, octyl group, nonyl group, decyl group and their isomers.

In the substituent B, the oxygen atom, the sulfur atom, or the amino group NR′; or the oxygen atom, the amino group NR′, or the sulfur atom of the alkylene ether group, alkyleneamino group, alkylene thioether group, aralkylene ether group, aralkyleneamino group, or aralkylene thioether group containing 1 to 20 carbon atoms having such atom or group at their terminal may preferably form a conjugated ester group, amide group, imide group, thioester group or the like together with the adjacent carbonyl group.

Among these, the substituent B is preferably oxygen atom, sulfur atom, or an amino group; or an alkylene ether group, an alkyleneamino group, or an alkylene thioether group containing 1 to 20 carbon atoms having such atom or group at its terminal, and more preferably, an amino group (NH), an alkyleneamino group (—NH—CH₂— group, —NH—CH₂CH₂— group, or —NH—CH₂CH₂CH₂— group), or an alkylene ether group (—O—CH₂— group, —O—CH₂CH₂— group, or —O—CH₂CH₂CH₂— group) forming a conjugated system.

The thermoplastic elastomer (A) used in the foam composition of the present invention preferably has the side chain having the structure represented by the formula (1) as a side chain containing a structure represented by the formula (2) or (3) which binds to the main chain at α position or β position:

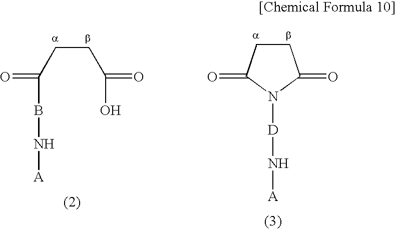

wherein A is an alkyl group containing 1 to 30 carbon atoms, an aralkyl group containing 7 to 20 carbon atoms, or an aryl group containing 6 to 20 carbon atoms; and B and D are independently a single bond; oxygen atom, an amino group NR′ (wherein R′ is hydrogen atom or an alkyl group containing 1 to 10 carbon atoms), or sulfur atom; or an organic group which may contain such atom or group.

In this formula, the substituent A is basically the same as the substituent A in the formula (1), and the substituent B and D are independently, basically the same as the substituent B in the formula (1).

However, of the examples as described above for the substituent B in the formula (1), the substituent D in the formula (3) is preferably a single bond; or an alkylene group or an aralkylene group containing 1 to 20 carbon atoms which may contain oxygen atom, an amino group NR′, or sulfur atom and which forms a conjugated system with the imide nitrogen, and most preferably such an alkylene group. More specifically, the substituent D may preferably form an alkyleneamino group or an aralkyleneamino group containing 1 to 20 carbon atoms which may contain oxygen atom, an amino group NR′, or sulfur atom with the imide nitrogen in the formula (3), and more preferably, such an alkyleneamino group.

Examples of the substituent D include a single bond; an alkylene ether group, an alkyleneamino group, an alkylene thioether group, an aralkylene ether group, an aralkyleneamino group, an aralkylene thioether group containing 1 to 20 carbon atoms and having oxygen atom, sulfur atom, or an amino group at its terminal; and methylene group, ethylene group, propylene group, butylene group, hexylene group, phenylene group, and xylylene group and their isomers.

In the present invention, the side chain containing the imino group and the carbonyl-containing group (which is typically a side chain containing the structure represented by the formula (1) or the formula (2) or (3)) is preferably incorporated in an amount (incorporation amount) of 0.1 to 50% by mole in relation to 100% by mole of the monomer constituting the elastomeric polymer. When the incorporation amount is less than 0.1% by mole, the strength after the crosslinking may be insufficient, and when the incorporation amount is in excess of 50% by mole, the crosslink density may become unduly high to invite loss of rubber elasticity. When the incorporation rate is within such range, the intermolecular or intramolecular interaction will occur with a good balance between the side chains of the elastomeric polymer and, and the resulting foam (composition) of the present invention will exhibit high tensile strength after the crosslinking, high recyclability, and also, an improved resistance to compression set. In view of further improving such properties, the side chain is preferably incorporated in an amount of 0.1 to 30% by mole, and more preferably at a rate of 0.5 to 20% by mole.

In the present invention, when the side chain contains a nitrogen-containing heterocycle and a carbonyl-containing group, the side chain may preferably contain a structure represented by the following formula (4):

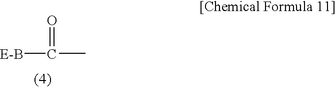

wherein E is a nitrogen-containing heterocycle, B and D are independently a single bond; oxygen atom, an amino group NR′ (wherein R′ is hydrogen atom or an alkyl group containing 1 to 10 carbon atoms), or sulfur atom; or an organic group which may contain such atom or group.

In this formula, the nitrogen-containing heterocycle E may be any of the nitrogen-containing heterocycles as described below.

The substituents B and D are independently, basically the same as the substituent B in the formula (1).

The nitrogen-containing heterocycle used may contain a heteroatom other than the nitrogen atom such as sulfur atom, oxygen atom or phosphorus atom as long as it contains the nitrogen atom in the heterocycle. A heterocyclic compound is used because a stronger hydrogen bond that constitutes the crosslink will be formed when a heterocyclic structure is adopted, and the resulting foam (composition) of the present invention will exhibit an improved tensile strength.

The nitrogen-containing heterocycle may also have a substituent. Examples of the substituent include alkyl groups such as methyl group, ethyl group, (iso)propyl group, and hexyl group; alkoxy groups such as methoxy group, ethoxy group, and (iso)propoxy group; a group containing a halogen atom such as fluorine atom, chlorine atom, bromine atom or iodine atom; cyano group; amino group; aromatic hydrocarbon group; ester group; ether group; acyl group; and thioether group. These may also be used as a combination of two or more. The position of substitution with such substituent and the number of substituents are not particularly limited.

Furthermore, the nitrogen-containing heterocycle may be either aromatic or nonaromatic. However, when the nitrogen-containing heterocycle is aromatic, the resulting foam (composition) of the present invention will exhibit higher tensile strength as well as improved mechanical strength after the crosslinking.

The nitrogen-containing heterocycle is preferably a five-membered ring or a six-membered ring.

Examples of such nitrogen-containing heterocycle include pyrrololine, pyrrolidone, oxindole (2-oxindole), indoxyl(3-oxindole), dioxindole, isatin, indolyl, phthalimidine, β-isoindigo, monoporphyrin, diporphyrin, triporphyrin, azaporphyrin, phthalocyanine, hemoglobin, uroporphyrin, chlorophyll, phylloerythrin, imidazole, pyrazole, triazole, tetrazole, benzimidazole, benzopyrazole, benzotriazole, imidazoline, imidazolone, imidazolidone, hydantoin, pyrazoline, pyrazolone, pyrazolidone, indazole, pyridoindole, purine, cinnoline, pyrrole, pyrroline, indole, indoline, oxylindole, carbazole, phenothiazine, indolenine, isoindole, oxazole, thiazole, isoxazole, isothiazole, oxadiazole, thiadiazole, oxatriazole, thiatriazole, phenanthroline, oxazine, benzoxazine, phthalazine, puteridine, pyrazine, phenazine, tetrazine, benzoxazole, benzisoxazole, anthranyl, benzothiazole, benzofurazan, pyridine, quinoline, isoquinoline, acridine, phenanthridine, anthrazoline, naphthyridine, thiazine, pyridazine, pyrimidine, quinazoline, quinoxaline, triazine, histidine, triazolidine, melamine, adenine, guanine, thymine, cytosine, and derivatives thereof. Among these, and particularly with regard to the nitrogen-containing five-membered ring, the preferred are the following compounds, a triazole derivative represented by the following formula (25), and an imidazole derivative represented by the following formula (26). These compounds are optionally substituted with various substituents as described above, and also, these compounds may be hydrogenated or dehydrogenated.

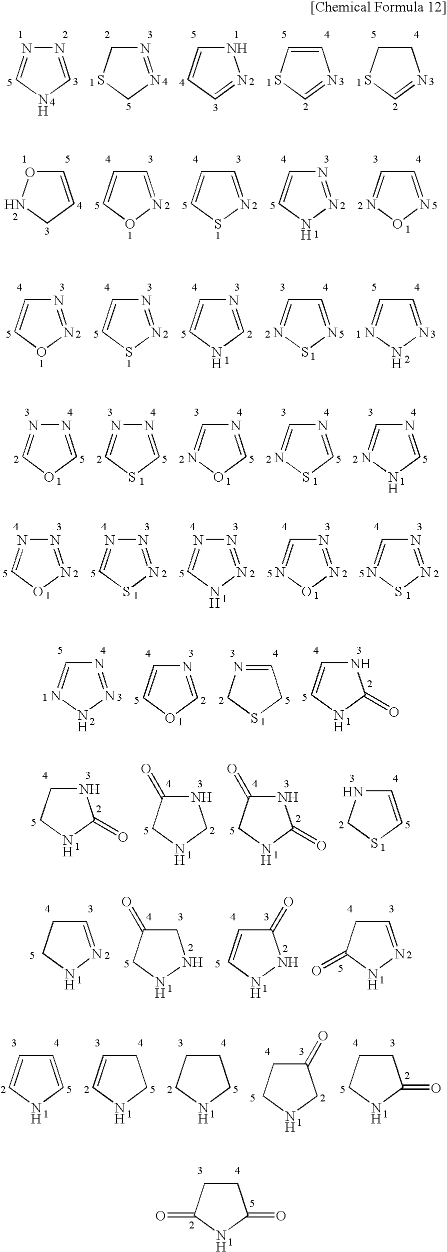

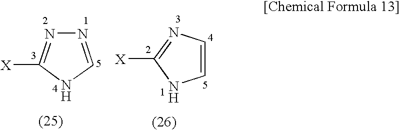

In the formulae, substituent X is an alkyl group containing 1 to 30 carbon atoms, an aralkyl group containing 7 to 20 carbon atoms, or an aryl group containing 6 to 20 carbon atoms, and is basically the same as the substituent A in the formula (1).

With regard to the nitrogen-containing six-membered ring, the preferred are the following compounds. As in the case of the five-membered ring, these compounds are optionally substituted with various substituents as described above, and also, these compounds may be hydrogenated or dehydrogenated.

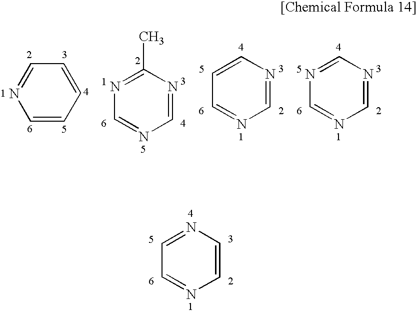

Also, the nitrogen-containing heterocycle fused with a benzene ring or the nitrogen-containing heterocycle fused with another nitrogen-containing heterocycle may be used. Preferable examples of such fused ring are as shown below. As in the case as described above, these fused rings are optionally substituted with various substituents as described above, and also, these rings may be hydrogenated or dehydrogenated.

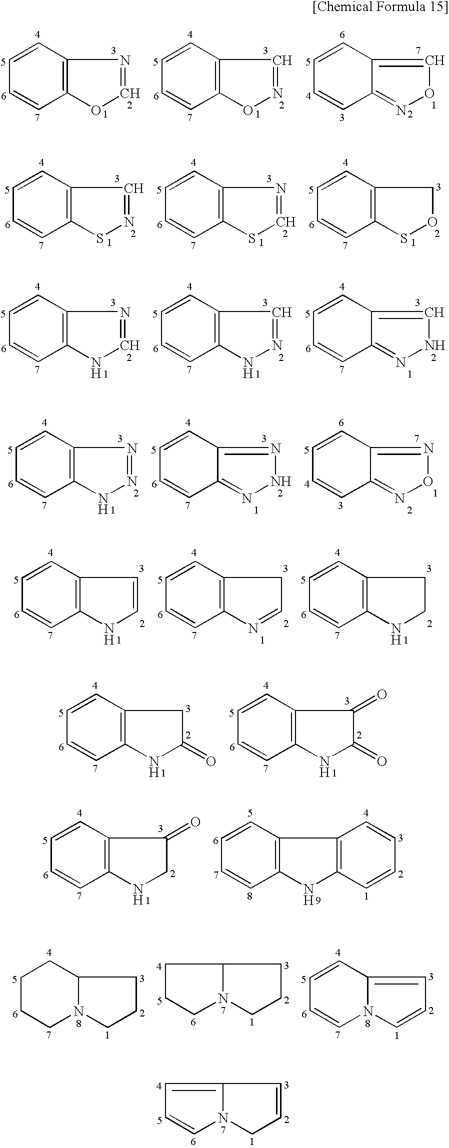

Among such nitrogen-containing heterocycles, use of triazole ring, thiadiazole ring, pyridine ring, thiazole ring, imidazole ring, or hydantoin ring is preferable in view of the excellent recyclability, resistance to compression set, mechanical strength, and hardness of the resulting foam (composition) of the present invention.

More preferably, the thermoplastic elastomer (A) used in the foam composition of the present invention may have the side chain having the structure represented by the formula (4) as a side chain having a structure represented by the formula (5) or (6) which binds to the main chain at α position or the β position:

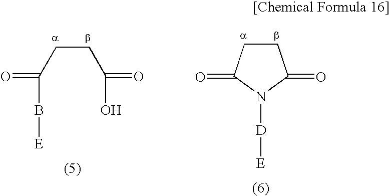

wherein E is a nitrogen-containing heterocycle, and B and D are independently a single bond; oxygen atom, an amino group NR′ (wherein R′ is hydrogen atom or an alkyl group containing 1 to 10 carbon atoms), or sulfur atom; or an organic group which may contain such atom or group.

In this formula, the nitrogen-containing heterocycle E may be any of the exemplary nitrogen-containing heterocycles as described above.

The substituents B and D are independently, basically the same as the substituent B in the formula (1).

However, the substituent D in the formula (6) is preferably a single bond; or alkylene group or aralkylene group containing 1 to 20 carbon atoms which may contain oxygen atom, an amino group NR′, or sulfur atom and which forms a conjugated system with the imide nitrogen, and most preferably a single bond. More specifically, the substituent D is preferably the one which forms an alkyleneamino group or an aralkyleneamino group containing 1 to 20 carbon atoms which may contain oxygen atom, an amino group NR′, or sulfur atom with the imide nitrogen in the formula (6), and more preferably, the nitrogen-containing heterocycle is directly bonded (by a single bond) to the imide nitrogen in the formula (6).

When the thermoplastic elastomer (A) used in the foam composition of the present invention has a side chain containing triazole ring, imidazole ring or thiazole ring as the side chain containing the nitrogen-containing heterocycle, the thermoplastic elastomer (A) may preferably have the side chain having the structure represented by the formula (4) as a side chain containing the structure represented by the following formula (7), the following formula (8) or (9), or the following formula (10):

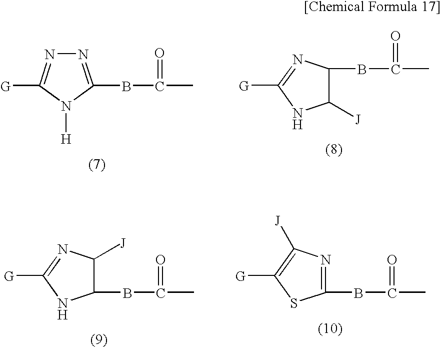

and more preferably, as a side chain containing the structure which binds to the main chain at α position or β position and is represented by the following formula (11) or (12), any one of the following formula (13) to (16), or the following formula (17) or (18):

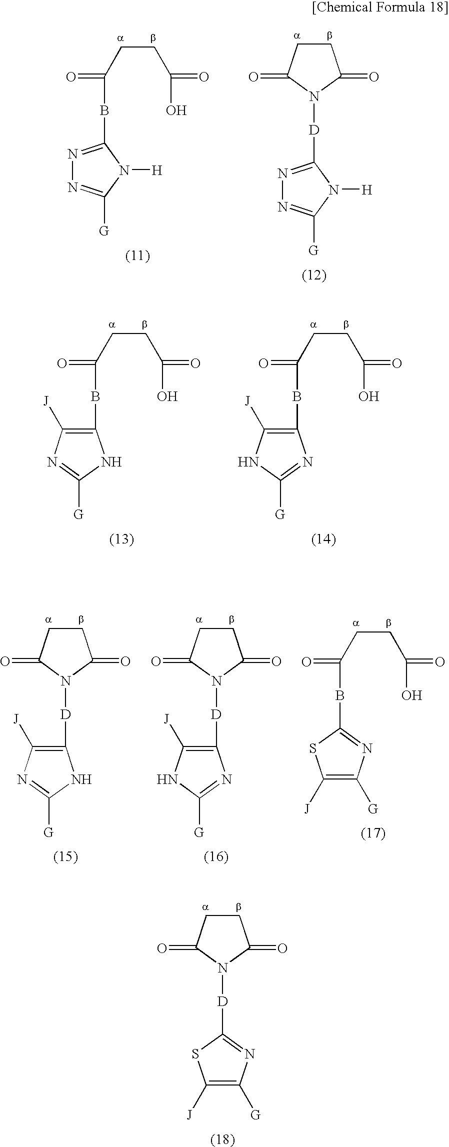

wherein B and D are independently a single bond; oxygen atom, an amino group NR′ (wherein R′ is hydrogen atom or an alkyl group containing 1 to 10 carbon atoms), or sulfur atom; or an organic group which may contain such atom or group, and G and J are independently hydrogen atom, an alkyl group containing 1 to 30 carbon atoms, an aralkyl group containing 7 to 20 carbon atoms, or an aryl group containing 6 to 20 carbon atoms.

In the formulae, the substituents B and D are independently, basically the same as the substituents B and D in the formulae (4) to (6).

With regard to the substituents G and J, examples include hydrogen atom; and those substituents described for the substituent A in the formula (1) including straight chain alkyl groups such as methyl group, ethyl group, propyl group, butyl group, pentyl group, octyl group, dodecyl group, and stearyl group; branched alkyl groups such as isopropyl group, isobutyl group, s-butyl group, t-butyl group, isopentyl group, neopentyl group, t-pentyl group, 1-methylbutyl group, 1-methylheptyl group, and 2-ethylhexyl group; aralkyl groups such as benzyl group, and phenethyl group; aryl groups such as phenyl group, tolyl group (o-, m-, p-), dimethylphenyl group, and mesityl group. The substituents G and J may be either the same or different.

In the present invention, the side chain containing the nitrogen-containing heterocycle and the carbonyl-containing group (which is typically a side chain containing the structure represented by the formula (4) or the formula (5) or (6)) is preferably incorporated in an amount (incorporation amount) of 0.1 to 50% by mole in relation to 100% by mole of the monomer constituting the elastomeric polymer. When the incorporation amount is less than 0.1% by mole, the strength after the crosslinking may be insufficient, and when the incorporation amount is in excess of 50% by mole, the crosslink density may become unduly high to invite loss of rubber elasticity. When the incorporation rate is within such range, the intermolecular or intramolecular interaction will occur with a good balance between the side chains of the elastomeric polymer, and the resulting foam (composition) of the present invention will exhibit high tensile strength after the crosslinking, high recyclability, and also, an improved resistance to compression set. In view of further improving such properties, the side chain is preferably incorporated in an amount of 0.1 to 30% by mole, and more preferably in an amount of 0.5 to 20% by mole.

In the present invention, when both of the side chain containing the imino group and the carbonyl-containing group and the side chain containing the nitrogen-containing heterocycle and the carbonyl-containing group are present, these side chains are preferably incorporated in a total amount (incorporation amount) of 0.1 to 50% by mole in relation to 100% by mole of the monomer constituting the elastomeric polymer; and these side chains are preferably incorporated at an incorporation ratio (the side chain containing the nitrogen-containing heterocycle and the carbonyl-containing group/the side chain containing the imino group and the carbonyl-containing group) of 1/99 to 99/1, and more preferably at 10/90 to 90/10.

When the incorporation rate and the incorporation ratio are within such range, mechanical strength such as tensile strength can be further improved and the coloring of the foam (composition) due to the presence of the nitrogen-containing heterocycle incorporated can be simultaneously suppressed without detracting from the properties such as the high tensile strength after the crosslinking, the high recyclability, and the improved resistance to compression set.

Next, the binding position of the nitrogen-containing heterocycle is described for the case when the thermoplastic elastomer (A) used in the foam composition of the present invention has the side chain containing the nitrogen-containing heterocycle. For the convenience of the description, the nitrogen-containing heterocycle described is “a nitrogen-containing n-membered ring compound (n≧3)”.

The binding position (“the 1- to n-position”) as described below is the one based on the IUPAC nomenclature. For example, when the compound has 3 nitrogen atoms each having an unshared electron pair, the binding position is determined by the order based on the IUPAC nomenclature. More specifically, the binding positions were indicated in the aforementioned nitrogen-containing heterocycles including the five-membered rings, the six-membered rings, and the fused rings.

In the thermoplastic elastomer (A), the binding position of the nitrogen-containing n-membered ring compound which binds to the copolymer directly or with an intervening organic group is not particularly limited, and the binding may take place at any position (at the 1- to n-position). Preferably, the binding position is the 1-position, or 3- to n-position.

When the nitrogen-containing n-membered ring compound contains one nitrogen atom (for example, as in the case of pyridine ring), the binding position is preferably 3-position to (n−1)-position because a chelate is more likely to be formed in the molecule, and the resulting foam composition will exhibit better physical properties including tensile strength.

When the binding position of the nitrogen-containing n-membered ring compound is adequately selected, crosslinking by hydrogen bond, ionic bond, coordinate bond, or the like will be promoted between the molecules of the thermoplastic elastomer, and the resulting product will exhibit improved recyclability as well as excellent mechanical properties.

In the present invention, when the side chain of the thermoplastic elastomer (A) contains a covalent crosslink site and a carbonyl-containing group, the crosslink is more preferably established at the covalent crosslink site by at least one bond selected from the group consisting of amide, ester, lactone, urethane, ether, thiourethane, and thioether. The thermoplastic elastomer (A) used in the foam composition of the present invention may also be the one wherein crosslink has been established by such a bond.

The side chain containing the covalent crosslink site and the carbonyl-containing group is not particularly limited as long as it is a side chain which has the carbonyl-containing group and also has for the covalent crosslink site, a functional group capable of generating at least one bond selected from the group consisting of amide, ester, lactone, urethane, ether, thiourethane, and thioether by reacting with “a compound which generates a covalent bond”.

In the present invention, examples of the “compound which generates a covalent bond” include a polyamine compound containing two or more amino groups and/or imino groups (two or more in total number of amino groups and imino groups when both groups are present) in one molecule; a polyol compound containing two or more hydroxy groups in one molecule; a polyisocyanate compound containing two or more isocyanate (NCO) groups in one molecule; and a polythiol compound containing two or more thiol groups (mercapto groups) in one molecule.

Exemplary polyamine compounds include an alicyclic amine, an aliphatic polyamine, an aromatic polyamine, and a nitrogen-containing heterocyclic amine as shown below.

Exemplary alicyclic amines include 1-amino-3-aminomethyl-3,5,5-trimethylcyclohexane, bis-(4-aminocyclohexyl)methane, diaminocyclohexane, and di-(aminomethyl)cyclohexane.

Exemplary aliphatic polyamines include methylenediamine, ethylenediamine, propylenediamine, 1,2-diaminopropane, 1,3-diaminopentane, hexamethylenediamine, diaminoheptane, diaminododecane, diethylenetriamine, diethylaminopropylamine, N-aminoethylpiperazine, triethylenetetramine, N,N′-dimethylethylenediamine, N,N′-diethylethylenediamine, N,N′-diisopropylethylenediamine, N,N′-dimethyl-1,3-propanediamine, N,N′-diethyl-1,3-propanediamine, N,N′-diisopropyl-1,3-propanediamine, N,N′-dimethyl-1,6-hexanediamine, N,N′-diethyl-1,6-hexanediamine, and N,N′,N″-trimethylbis(hexamethylene)triamine, and polyethyleneimine.

Exemplary aromatic polyamines and nitrogen-containing heterocyclic amines include diaminotoluene, diaminoxylene, tetramethylxylylenediamine, tris(dimethylaminomethyl)phenol, metaphenylenediamine, diaminodiphenylmethane, diaminodiphenylsulfone, and 3-amino-1,2,4-triazole.

The polyamine compound may optionally have at least one of its hydrogen atoms substituted with an alkyl group, an alkylene group, an aralkylene group, oxy group, an acyl group, a halogen atom, or the like. The polyamine compound may also include a hetero atom such as oxygen atom or sulfur atom in its skeleton.

The polyamine compound may be used alone or in combination of two or more. When two or more polyamine compounds are used, they may be mixed at any ratio depending on the application of the foam (composition) of the present invention and the physical properties and other factors required for the foam (composition) of the present invention.

Of the polyamine compounds described above, the preferred are hexamethylenediamine, N,N′-dimethyl-1,6-hexanediamine, diaminodiphenylsulfone, and polyethyleneimine in view of the remarkable effect of improving the resistance to compression set and mechanical strength, in particular, tensile strength.

The polyol compound is not particularly limited for its molecular weight and skeleton as long as it has two or more hydroxy groups, and examples thereof include polyether polyols, polyester polyols, other polyols, and mixtures thereof as described below.

Exemplary polyether polyols include the polyols produced by adding at least one member selected from ethylene oxide, propylene oxide, butylene oxide, styrene oxide, and the like to at least one member selected from polyhydric alcohols such as ethylene glycol, diethylene glycol, propylene glycol, dipropylene glycol, glycerin, 1,1,1-trimethylolpropane, 1,2,5-hexanetriol, 1,3-butanediol, 1,4-butanediol, 4,4′-dihydroxyphenylpropane, 4,4′-dihydroxyphenylmethane, and pentaerythritol; and polyoxytetramethylene oxide; which may be used alone or in combination of two or more.

Exemplary polyester polyols include condensation polymers of one or more low molecular weight polyols such as ethylene glycol, propylene glycol, butanediol pentanediol, hexanediol, cyclohexane dimethanol, glycerin, and 1,1,1-trimethylolpropane with one or more of low molecular weight carboxylic acids and oligomeric acids such as glutaric acid, adipic acid, pimelic acid, suberic acid, sebacic acid, terephthalic acid, isophthalic acid, and dimer acid; and ring-opening polymers such as propiolactone and valerolactone; which may be used alone or in combination of two or more.

Exemplary other polyols include polymer polyols, polycarbonate polyols; polybutadiene polyols; hydrogenated polybutadiene polyols; acrylic polyols; and low molecular weight polyols such as ethylene glycol, diethylene glycol, propylene glycol, dipropylene glycol, butanediol, pentanediol, hexanediol, polyethylene glycol laurylamine (for example, N,N-bis(2-hydroxyethyl)laurylamine), polypropylene glycol laurylamine (for example, N,N-bis(2-methyl-2-hydroxyethyl)laurylamine), polyethylene glycol octylamine (for example, N,N-bis(2-hydroxyethyl)octylamine), polypropylene glycol octylamine (for example, N,N-bis 2-methyl-2-hydroxyethyl)octylamine), polyethylene glycol stearylamine (for example, N,N-bis(2-hydroxyethyl)stearylamine), and polypropylene glycol stearylamine (for example, N,N-bis(2-methyl-2-hydroxyethyl)stearylamine); which may be used alone or in combination of two or more.

Exemplary polyisocyanate compounds include diisocyanate compounds such as aromatic polyisocyanates such as 2,4-tolylene diisocyanate (2,4-TDI), 2,6-tolylene diisocyanate (2,6-TDI), 4,4′-diphenylmethane diisocyanate (4,4′-MDI), 2,4′-diphenylmethane diisocyanate (2,4′-MDI), 1,4-phenylene diisocyanate, xylylene diisocyanate (XDI), tetramethylxylylene diisocyanate (TMXDI), tolidine diisocyanate (TODI), and 1,5-naphthalene diisocyanate (NDI); aliphatic polyisocyanates such as hexamethylene diisocyanate (HDI), trimethylhexamethylene diisocyanate (TMHDI), lysine diisocyanate, and norbornane diisocyanate methyl (NBDI); alicyclic polyisocyanates such as transcyclohexane-1,4-diisocyanate, isophorone diisocyanate (IPDI), H₆XDI (hydrogenated XDI), H₁₂MDI (hydrogenated MDI), and H₆TDI (hydrogenated TDI); polyisocyanate compounds such as polymethylene polyphenylene polyisocyanate; carbodiimide-modified polyisocyanates of such isocyanate compounds; isocyanurate-modified polyisocyanates of such isocyanate compounds; and urethane prepolymers obtained by reacting such isocyanate compounds with the polyol compounds as described above; which may be used alone or in combination of two or more.

The polythiol compound is not limited for its molecular weight and skeleton as long as it is a compound containing two or more thiol groups, and exemplary polythiol compounds include methanedithiol, 1,3-butanedithiol, 1,4-butanedithiol, 2,3-butanedithiol, 1,2-benzenedithiol, 1,3-benzenedithiol, 1,4-benzenedithiol, 1,10-decanedithiol, 1,2-ethanedithiol, 1,6-hexanedithiol, 1,9-nonanedithiol, 1,8-octanedithiol, 1,5-pentanedithiol, 1,2-propanedithiol, 1,3-propanedithiol, toluene-3,4-dithiol, 3,6-dichloro-1,2-benzenedithiol, 1,5-naphthalenedithiol, 1,2-benzenedimethanethiol, 1,3-benzenedimethanethiol, 1,4-benzenedimethanethiol, 4,4′-thiobisbenzenethiol, 2,5-dimercapto-1,3,4-thiadiazole, 1,8-dimercapto-3,6-dioxaoctane, 1,5-dimercapto-3-thiapentane, 1,3,5-triazine-2,4,6-trithiol (trimercapto-triazine), 2-di-n-butylamino-4,6-dimercapto-s-triazine, trimethylolpropane tris(β-thiopropionate), trimethylolpropane tris(thioglycolate), and polythiol (Thiokol- or thiol-modified polymer (resin, rubber, etc.); which may be used alone or in combination of two or more.

Preferable examples of the functional group which is capable of generating at least one bond selected from the group consisting of amide, ester, lactone, urethane, ether, thiourethane, and thioether by reacting with such “compound which generates a covalent bond” include cyclic acid anhydride group, hydroxy group, amino group, carboxy group, isocyanate group, and thiol group.

Other side chains containing the covalent crosslink site are not particularly limited as long as it is the one containing such functional group.

In the thermoplastic elastomer (A) used in the foam composition of the present invention, it is preferable for at least one crosslink at the covalent crosslink site, namely, at least one crosslink by the covalent bonding between the functional group and the “compound which generates a covalent bond” to be included in one molecule, and in particular, when crosslink is formed by at least one bond selected from the group consisting of lactone, urethane, ether, thiourethane, and thioether, preferably 2 or more, more preferably 2 to 20, and most preferably 2 to 10 crosslinks are included in one molecule.

In the present invention, the crosslink at such covalent crosslink site preferably contains a tertiary amino group (—N═) in view of the improved resistance to compression set and mechanical strength (elongation at break and breaking strength) of the resulting foam (composition) of the present invention. This effect is believed to have been realized by the increase in the crosslink density owing to the hydrogen bond (interaction) of the tertiary amino group with the carbonyl-containing group and the nitrogen-containing heterocycle. Accordingly, of those shown above, preferable examples of the “compound which generates a covalent bond” are polyethylene glycol laurylamine (for example, N,N-bis(2-hydroxyethyl)laurylamine), polypropylene glycol laurylamine (for example, N,N-bis(2-methyl-2-hydroxyethyl)laurylamine), polyethylene glycol octylamine (for example, N,N-bis(2-hydroxyethyl)octylamine), polypropylene glycol octylamine (for example, N,N-bis(2-methyl-2-hydroxyethyl)octylamine), polyethylene glycol stearylamine (for example, N,N-bis(2-hydroxyethyl)stearylamine), and polypropylene glycol stearylamine (for example, N,N-bis(2-methyl-2-hydroxyethyl)stearylamine).

In the present invention, the crosslink at the covalent crosslink site preferably contains at least one structure represented by any one of the following formulae (19) to (21):

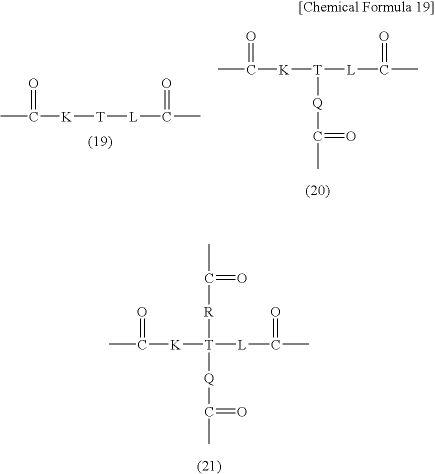

wherein K, L, Q, and R are independently a single bond; oxygen atom, an amino group NR′ (wherein R′ is hydrogen atom or an alkyl group containing 1 to 10 carbon atoms), or sulfur atom; or an organic group which may contain such atom or group, T is an optionally branched hydrocarbon group which contains oxygen atom, sulfur atom, or nitrogen atom. More preferably, T in the formulae contains a tertiary amino group.

In the formulae, the substituents K, L, Q, and R are independently, basically the same as the substituent B in the formula (1).

The substituent T is preferably an optionally branched hydrocarbon group containing 1 to 20 carbon atoms, and examples include alkylene groups such as methylene group, ethylene group, 1,3-propylene group, 1,4-butylene group, 1,5-pentylene group, 1,6-hexylene group, 1,7-heptylene group, 1,8-octylene group, 1,9-nonylene group, 1,10-decylene group, 1,11-undecylene group, and 1,12-dodecylene group; N,N-diethyldodecylamine-2,2′-diyl, N,N-dipropyldodecylamine-2,2′-diyl, N,N-diethyloctylamine-2,2′-diyl, N,N-dipropyloctylamine-2,2′-diyl, N,N-diethylstearylamine-2,2′-diyl, and N,N-dipropylstearylamine-2,2′-diyl; vinylene group; divalent alicyclic hydrocarbon groups such as 1,4-cyclohexylene group, and polyethyleneimine group; divalent aromatic hydrocarbon groups such as 1,4-phenylene group, 1,2-phenylene group, 1,3-phenylene group, and 1,3-phenylenebis(methylene) group; trivalent hydrocarbon groups such as propane-1,2,3-triyl, butane-1,3,4-triyl, trimethylamine-1,1′,1″-triyl, and triethylamine-2,2′,2″-triyl; tetravalent hydrocarbon groups represented by the following formulae (27) and (28):

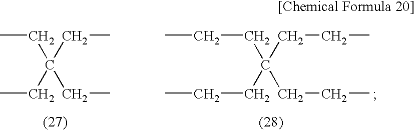

and substituents formed by combining two or more of such substituents.

Furthermore, in the present invention, the crosslink at the covalent crosslink site preferably contains at least one structure represented by any one of the following formulae (22) to (24) which binds to the main chain of the elastomeric polymer at α position or β position, and in these formulae, T more preferably contains a tertiary amino group. Preferable examples of the structure represented by any one of the formulae (22) to (24) include compounds represented by the formulae (29) to (40).

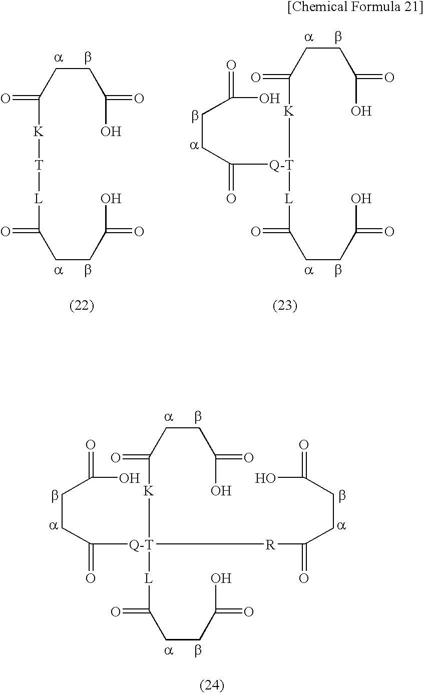

[In these formulae, the substituents K, L, Q, and R are independently, basically the same as the substituents K, L, Q, and R in the formulae (19) to (21), and the substituent T is basically the same as the substituent T in the formula (19).]

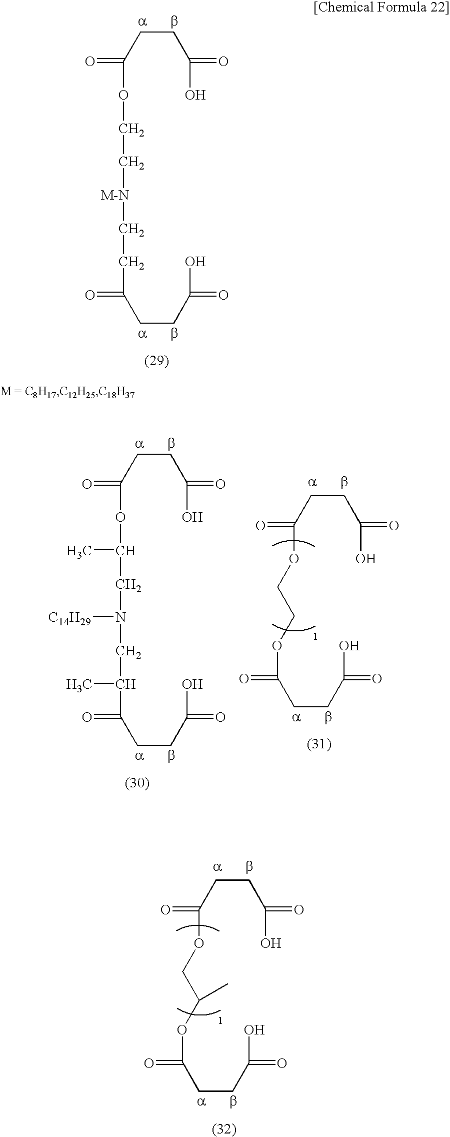

[In these formulae, l represents an integer of at least 1.]

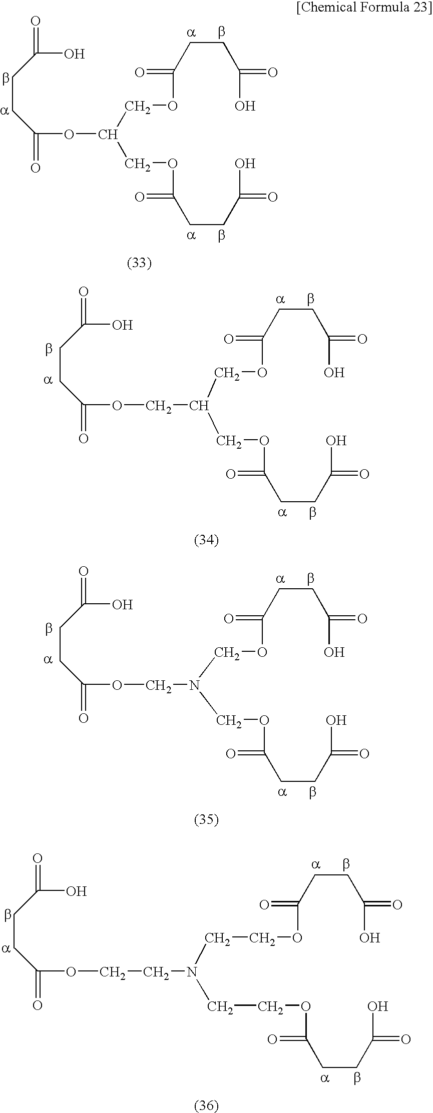

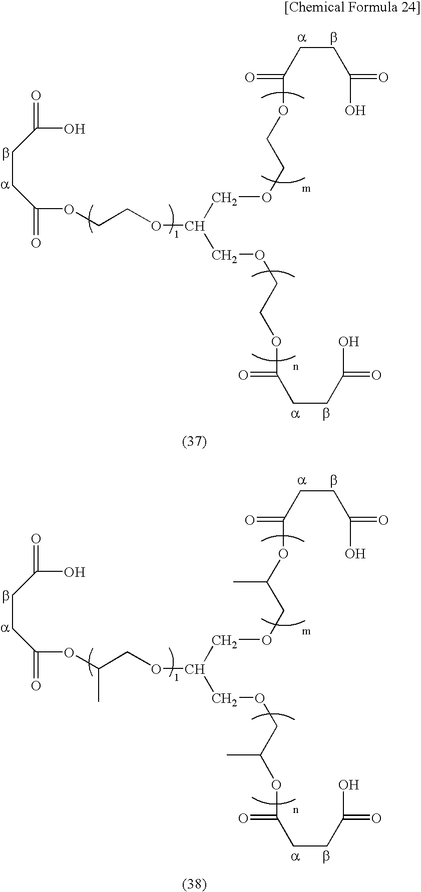

[In these formulae, l, m, and n independently represent an integer of at least 1.]

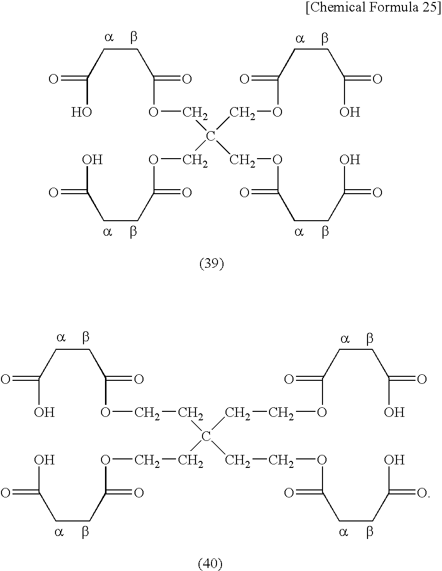

In the present invention, the crosslink at the covalent crosslink site is preferably formed by the reaction of the cyclic acid anhydride group with the hydroxy group or the amino group and/or the imino group.

The thermoplastic elastomer (A) used in the foam composition of the present invention preferably has a glass transition point of not higher than 25° C., and when the elastomeric polymer has two or more glass transition points or when two or more thermoplastic elastomers are used as a mixture, at least one of the glass transition points is preferably not higher than 25° C. When the glass transition point is not higher than 25° C., the molded article will exhibit rubber elasticity at room temperature.

The foam composition of the present invention contains at least one such thermoplastic elastomer. When two or more thermoplastic elastomers are used, they may be mixed at any ratio depending on the application of the foam (composition) of the present invention and the physical properties and other factors required for the composition.

The method employed in producing the thermoplastic elastomer (A) used in the foam composition of the present invention is not particularly limited, and any method commonly used in the art may be selected.

More specifically, an exemplary preferable method for producing the thermoplastic elastomer (A) having the side chain containing the imino group and the carbonyl-containing group is a production method comprising the reaction step (hereinafter referred to as “reaction step A”) of reacting an elastomeric polymer having a side chain containing a cyclic acid anhydride group with a compound capable of introducing imino group. An exemplary preferable method for producing the thermoplastic elastomer (A) having the side chain containing the nitrogen-containing heterocycle and the carbonyl-containing group is a production method comprising the reaction step (hereinafter referred to as “reaction step B”) of reacting an elastomeric polymer having a side chain containing a cyclic acid anhydride group with a compound capable of introducing a nitrogen-containing heterocycle. With regard to the method for producing the thermoplastic elastomer (A) having the side chain containing the imino group, the nitrogen-containing heterocycle and the carbonyl-containing group, an exemplary preferable method is a method including both the reaction step A and the reaction step B. This method may include the reaction step B as a step simultaneously conducted with the reaction step A, or as a step conducted before or after the reaction step A. However, the reaction step B is preferably included as a step conducted after the reaction step A.

In the meanwhile, exemplary preferable methods for producing the thermoplastic elastomer (A) having the side chain containing the covalent crosslink site and the carbonyl-containing group include a production method comprising the reaction step (hereinafter referred to as “reaction step C”) of reacting the elastomeric polymer with a compound which is capable of introducing the cyclic acid anhydride group as described below, and a production method comprising the reaction step (hereinafter referred to as “reaction step D”) of further reacting the elastomeric polymer having a side chain containing a cyclic acid anhydride group produced by the above method with the compound which generates the covalent bond as described above.

Next, the elastomeric polymer having a side chain containing a cyclic acid anhydride group, the compound capable of introducing imino group, the compound capable of introducing a nitrogen-containing heterocycle, and the reaction steps A to D are described in detail.

(Elastomeric Polymer Having a Side Chain Containing a Cyclic Acid Anhydride Group)

The elastomeric polymer having a side chain containing a cyclic acid anhydride group is an elastomeric polymer in which a cyclic acid anhydride group is bonded (covalently bonded) to an atom constituting the main chain in a chemically stable manner, and such elastomeric polymer is produced by reacting the elastomeric polymer as described above with a compound capable of introducing a cyclic acid anhydride group.

Exemplary compounds capable of introducing a cyclic acid anhydride group include cyclic acid anhydrides such as succinic anhydride, maleic anhydride, glutaric anhydride, and phthalic anhydride.

In the present invention, the elastomeric polymer having a side chain containing a cyclic acid anhydride group used may be the one produced by a commonly used method, for example, by a method in which a cyclic acid anhydride is graft polymerized with the elastomeric polymer under commonly used conditions such as stirring under heating. The elastomeric polymer may also be a commercially available product.

Exemplary such commercial products include maleic anhydride-modified isoprene rubbers such as LIR-403 (manufactured by Kuraray Co., Ltd.) and LIR-410A (a prototype manufactured by Kuraray Co., Ltd.); modified isoprene rubbers such as LIR-410 (manufactured by Kuraray Co., Ltd.); carboxy-modified nitrile rubbers such as Krynac 110, 221, and 231 (manufactured by Polysar Ltd.); carboxy-modified polybutenes such as CPIB (manufactured by Nippon Petrochemicals Co., Ltd.), and HRPIB (a prototype in the laboratory of Nippon Petrochemicals Co., Ltd.); maleic anhydride-modified ethylene-propylene rubbers such as Nucrel (manufactured by DuPont-Mitsui Polychemicals Co., Ltd.), Yukaron (manufactured by Mitsubishi Chemical Corporation), and TAFMER M (for example, MA8510 (manufactured by Mitsui Chemicals, Inc.)); maleic anhydride-modified ethylene-butene rubbers such as TAFMER M (for example, MH7020 (manufactured by Mitsui Chemicals, Inc.)); maleic anhydride-modified polyethylenes such as ADTEX series (maleic anhydride-modified EVA, maleic anhydride-modified EMA (manufactured by Japan Polyolefins Co., Ltd.)), HPR series (maleic anhydride-modified EEA, maleic anhydride-modified EVA (manufactured by Mitsui-DuPont Polyolefin)), Bondfast series (maleic anhydride-modified EMA (manufactured by Sumitomo Chemical Co., Ltd.)), Dumilan series (maleic anhydride-modified EVOH (manufactured by Takeda Pharmaceutical Co., Ltd.)), BONDINE (maleic anhydride-modified EEA (manufactured by ATOFINA)), Tuftec (maleic anhydride-modified SEBS, M1943 (manufactured by Asahi Kasei Corporation)), KRATON (maleic anhydride-modified SEBS, FG1901X (manufactured by Kraton Polymers)), Tufprene (maleic anhydride-modified SBS, 912 (manufactured by Asahi Kasei Corporation)), SEPTON (maleic anhydride-modified SEPS (manufactured by Kuraray Co., Ltd.)), REXPEARL (maleic anhydride-modified EEA, ET-182G, 224M, 234M (manufactured by Japan Polyolefins Co., Ltd.)), and Auroren (maleic anhydride-modified EEA, 200S, 250S (manufactured by Nippon Paper Chemicals Co., Ltd.)); and maleic anhydride-modified polypropylenes such as Admer (for example, QB550, LF128 (manufactured by Mitsui Chemicals, Inc.)).

(Compound Capable of Introducing Imino Group)

The compound capable of introducing imino group is not particularly limited as long as it is a compound having imino group which does not constitute a part of a cyclic compound such as a heterocycle and other active hydrogen group (for example, hydroxy group, thiol group, amino group, etc.) in its molecule. Examples include alkylamino alcohols such as N-methylaminoethanol, N-ethylaminoethanol, N-n-propylaminoethanol, N-n-butylaminoethanol, N-n-pentylaminoethanol, N-n-hexylaminoethanol, N-n-heptylaminoethanol, N-n-octylaminoethanol, N-n-nonylaminoethanol, N-n-decylaminoethanol, N-n-undecylaminoethanol, N-n-dodecylaminoethanol, N-(2-ethylhexyl)aminoethanol, N-methylaminopropanol, and N-methylaminobutanol; aromatic amino alcohols such as N-phenylaminoethanol, N-toluoylaminoethanol, N-phenylaminopropanol, and N-phenylaminobutanol; alkylaminothiols such as N-methylaminoethanethiol, N-ethylaminoethanethiol, N-n-propylaminoethanethiol, N-n-butylaminoethanethiol, N-methylaminopropanethiol, and N-methylaminobutanethiol; aromatic aminothiols such as N-phenylaminoethanethiol, N-toluoylaminoethanethiol, N-phenylaminopropanethiol, and N-phenylaminobutanethiol; alkyldiamines such as N-methylethylenediamine, N-ethylethylenediamine, N-n-propylethylenediamine, N-methylpropanediamine, N-ethylpropanediamine, N-methylbutanediamine, N,N′-dimethylethylenediamine, and N,N′-diethylethylenediamine; aromatic diamines such as N-phenylethylenediamine, N-phenylpropanediamine, N-phenylbutanediamine, and N,N′-diphenylethylenediamine.

Among these, the preferred are N-n-butylaminoethanol, N-n-octylaminoethanol, and N-n-dodecylaminoethanol.

(A Compound Capable of Introducing a Nitrogen-Containing Heterocycle)

The compound capable of introducing a nitrogen-containing heterocycle may be the nitrogen-containing heterocycle itself as described above, or a nitrogen-containing heterocycle which has a substituent (for example, hydroxy group, thiol group, amino group, etc.) which reacts with a cyclic acid anhydride group such as maleic anhydride.

(Reaction Step A)

The reaction step A is the step in which the compound capable of introducing imino group and the elastomeric polymer having a side chain containing a cyclic acid anhydride group are mixed to promote a reaction (ring opening of the cyclic acid anhydride group) at a temperature (for example, 60 to 250° C.) at which the compound and the cyclic acid anhydride group can undergo chemical bonding. The side chain of the thermoplastic elastomer (A) obtained by the reaction will contain the structure represented by the formula (2) or (3).

The compound capable of introducing imino group may be reacted with a part or all of the cyclic acid anhydride group in the side chain of the elastomeric polymer. In this context, “a part” preferably means at least 1% by mole, more preferably at least 10% by mole, and most preferably 30% by mole in relation to 100% by mole of the cyclic acid anhydride group. When the compound is used in an amount within such range, favorable physical properties (for example, breakage-resisting properties) will be fully developed, and resistance to compression set will also be improved.

(Reaction Step B)

The reaction step B is the step in which a compound capable of introducing a nitrogen-containing heterocycle is mixed with an elastomeric polymer having a side chain containing a cyclic acid anhydride group to promote reaction (ring opening of the cyclic acid anhydride group) at a temperature (for example, 60 to 250° C.) at which the compound and the cyclic acid anhydride group can undergo chemical bonding. The side chain of the thermoplastic elastomer (A) produced by this reaction will contain the structure represented by the formula (5) or (6).

The compound capable of introducing a nitrogen-containing heterocycle may be reacted with a part or all of the cyclic acid anhydride group in the side chain of the elastomeric polymer. In this context, “a part” preferably means at least 1% by mole, more preferably at least 50% by mole, and most preferably at least 80% by mole in relation to 100% by mole of the cyclic acid anhydride group. When the compound is used in an amount within such range, the effects of introducing the nitrogen-containing heterocycle will be fully developed, and tensile strength and other mechanical strength after the crosslinking will also be improved.

When the compound capable of introducing imino group and the compound capable of introducing a nitrogen-containing heterocycle are simultaneously used, both the reaction step A and the reaction step B will be conducted. In such a case, the compound capable of introducing imino group and the compound capable of introducing a nitrogen-containing heterocycle may be reacted with a part or all of the cyclic acid anhydride group in the side chain of the elastomeric polymer. Although the amount of each compound reacted with the cyclic acid anhydride group is not particularly limited, these compounds may be preferably reacted in a total amount of at least 1% by mole, more preferably at least 50% by mole, and most preferably at least 80% by mole in relation to 100% by mole of the cyclic acid anhydride group. When these compounds are used in amounts within such ranges, the resulting product will exhibit improved tensile properties, resistance to compression set, and tensile strength after the crosslinking without detracting from the recyclability.

The ratio between these compounds reacted with the cyclic acid anhydride group (the compound capable of introducing imino group:the compound capable of introducing a nitrogen-containing heterocycle) is preferably in the range of 1:99 to 99:1, more preferably 10:90 to 99:1, and most preferably 20:80 to 90:10.

(Reaction Step C)

The reaction step C is the step in which an elastomeric polymer is reacted with a compound capable of introducing a cyclic acid anhydride group to produce an elastomeric polymer having a side chain containing a cyclic acid anhydride group.

(Reaction Step D)

The reaction step D is the step in which an elastomeric polymer having a side chain containing a cyclic acid anhydride group is mixed with a compound capable of generating covalent bond to promote a reaction (ring opening of the cyclic acid anhydride group) at a temperature (for example, 60 to 250° C.) at which the cyclic acid anhydride group and the compound can undergo chemical bonding. The side chain of the thermoplastic elastomer produced by this reaction will contain the structure represented by any of the formulae (22) to (24).

The compound which generates covalent bond may be reacted with a part or all of the cyclic acid anhydride group in the side chain of the elastomeric polymer. In this context, “a part” preferably means at least 1% by mole, more preferably at least 10% by mole, and most preferably at least 30% by mole in relation to 100% by mole of the cyclic acid anhydride group. When the compound is used within such range, favorable physical properties (for example, breakage-resisting properties) will be fully developed, and resistance to compression set will also be improved.

Such production method may also be, for example, a method in which an elastomeric polymer having a side chain containing a cyclic acid anhydride group and a compound capable of introducing imino group and/or a compound capable of introducing a nitrogen-containing heterocycle are mixed at 60 to 250° C. in a roll mill, kneader, single screw extruder, twin screw extruder, a universal blender, or the like.

In such production method, presence of various unreacted groups (structures) in the side chain of the thermoplastic elastomer (A), namely, the cyclic acid anhydride group and the structures represented by the formulae (2), (3), (5), and (6), and the like can be confirmed by commonly used analytical means such as NMR, and IR spectroscopy.

<Thermoplastic Polymer (B)>

The thermoplastic polymer (B) used in the foam composition according to the second aspect of the present invention is not particularly limited as long as it is thermoplastic, and examples of the thermoplastic polymer (B) include ethylene-propylene copolymer, soft polyolefin resin, propylene-butene copolymer, and ethylene-octene or ethylene-butene copolymer.

Examples of such thermoplastic polymer (B) employed include commercially available products such as ethylene-propylene copolymer (TAFMER P0775, manufactured by Mitsui Chemicals, Inc.), ethylene-propylene copolymer (TAFMER P0080K, manufactured by Mitsui Chemicals, Inc.), soft polyolefin resin (M142E, manufactured by Idemitsu Kosan Co., Ltd.), soft polyolefin resin (Catalloy series, manufactured by SunAllomer Ltd.), soft polyolefin resin (NEWCON series, manufactured by Japan Polypropylene Corporation), propylene-butene copolymer (VESTOPLAST, manufactured by Degussa), and ethylene-octene or ethylene-butene copolymer (Engage series, manufactured by DuPont Dow Elastomers Japan).

In the second aspect of the present invention, the thermoplastic polymer (B) may preferably have an MFR (melt mass-flow rate) of at least 0.01 g/10 min, and more preferably 0.1 to 100 g/10 min as measured at 230° C. under the load of 2.16 kg.

The MFR is the value measured according to “Plastics—Testing method for melt mass-flow rate (MFR) of thermoplastics” defined in JIS K 7210: 1999.

When the MFR is within such range, viscosity adjustment of the thermoplastic elastomer composition containing the thermoplastic elastomer (A), the thermoplastic polymer (B), and the internal release agent (C) as described below will be facilitated, and hence, adjustment of the foaming rate of the resulting foam composition will also be facilitated.

In the second aspect of the present invention, the content of the thermoplastic polymer (B) is preferably 1 to parts by weight, and more preferably 10 to 300 parts by weight in relation to 100 parts by weight of the thermoplastic elastomer (A).

In the second aspect of the present invention, the thermoplastic elastomer (A) and the thermoplastic polymer (B) may preferably have, in view of the favorable compatibility between the thermoplastic elastomer (A) and the thermoplastic polymer (B), a solubility parameter (Sp) value which satisfies the following inequality:

$$0.9 < \frac{S p ( A )}{S p ( B )} < 1.1 \qquad [ Mathematical Formula 2 ]$$

wherein Sp(A) represents the solubility parameter of the thermoplastic elastomer (A), and Sp(B) represents the solubility parameter of the thermoplastic polymer (B).

<Internal Release Agent (C)>

The internal release agent (C) used in the foam composition according to the second aspect of the present invention is not particularly limited as long as it is a compound capable of reducing the stickiness of the composition, and examples include fatty acid amides, fatty acid esters, fatty acid metal salts, and metallic compounds, which may be used alone or in combination of two or more.

More specifically, the internal release agent (C) used may be a commercially available product such as a mixture of a fatty acid amide, a fatty acid ester, and a metal salt of a fatty acid (for example, Struktol HT 204, manufactured by Schill Seilacher).

In the second aspect of the present invention, the content of the internal release agent (C) is preferably 0.1 to 50 parts by weight, and more preferably 0.1 to 20 parts by weight in relation to 100 parts by weight of the thermoplastic elastomer (A).

In the second aspect of the present invention, the thermoplastic elastomer composition containing the thermoplastic elastomer (A), the thermoplastic polymer (B), and the internal release agent (C) may preferably have a capillary viscosity of at least 3000 Pa·s, and more preferably at least 5000 Pa·s as measured at 120° C. and at a shear rate of 60.8 s⁻¹.

In the present invention, the capillary viscosity is the value measured according to “Plastics—Testing method of flow characteristics of plastics using capillary rheometers” defined in JIS K 7199: 1999.

When the capillary viscosity is within such range, the resulting foam composition will exhibit an improved foaming rate, and the resulting product will have a reduced weight and an improved cushion property.

In the second aspect of the present invention, the thermoplastic elastomer composition will exhibit improved surface texture when it is extruded from an extruder since it contains the thermoplastic polymer (B) and the internal release agent (C). This effect is believed to have been achieved by the improvement in the flowability realized by the thermoplastic polymer (B) combined with the reduction of stickiness realized by the internal release agent (C).

<Blowing Agent (D)>

The blowing agent (D) used in the foam composition of the present invention is not particularly limited as long as it generates a gas when it is mixed with a material and subjected to heat or the like to thereby form bubbles in the product, and such blowing agents are generally classified into physical blowing agents and chemical blowing agents.

Exemplary physical blowing agents include inorganic blowing agents such as nitrogen, air, carbon dioxide, ammonia, water, and hollow glass balloon; and organic blowing agents such as pentane, dichloroethane, and CFC.

Exemplary chemical blowing agents include inorganic blowing agents such as the one which works by the reaction between an acid and sodium bicarbonate, and thermolytic blowing agents such as carbonate; and organic blowing agents such as the one which works by the reaction of, for example, an isocyanate compound, and a thermolytic blowing agent in which at least one selected from the group consisting of azo compound, hydrazine derivative, semicarbazide compound, azide, nitroso compound, triazole compound, tetrazole compound, and bicarbonate is used.

Exemplary thermolytic organic chemical blowing agents include azodicarbonamide (ADCA), diazoaminobenzene (C₆H₅N═NHC₆H₅), N,N′-dinitrosopentamethylenetetramine (DPT), 4,4′-oxybis(benzene sulfonyl hydrazide) (OBSH), hydrazodicarbonamide (HDCA), barium azodicarboxylate (Ba/AC), sodium hydrogencarbonate (NaHCO₃), ammonium carbonate ((NH₄)₂CO₃), and aluminum acetate (Al(CH₃COO)₃), which may be commercially available products such as ADCA (trade name, VINYFOR), DPT (trade name, CELLULAR), OBSH (trade name, NEOCELLBORN), DPT/ADCA (trade name, EXCELLAR), ADCA/OBSH (trade name, SPANGCELL), or NaHCO₃ (trade name, CELLBORN) manufactured by Eiwa Chemical Ind. Co., Ltd.

When such blowing agent (D) is incorporated with the thermoplastic elastomer (A), the resulting foam (composition) of the present invention will exhibit reduced hardness and density as well as reduced weight and improved cushion property. While such effects are achieved based on the incorporation of the blowing agent, the effects are more distinguished in the foam (composition) of the present invention employing the thermoplastic elastomer (A) compared, for example, to the foam (composition) employing dynamically crosslinked thermoplastic elastomer (TPV).

More specifically, in the case of the dynamically crosslinked thermoplastic elastomer (TPV), it contains a large amount of crosslinked rubber, and accordingly, the matrix has less space for the thermoplastic resin, and foaming is less likely to take place even at a high temperature (for example, at a temperature as high as 200° C.). In contrast, the foam (composition) of the present invention has improved foamability as well as improved tensile strength after crosslinking because, as will be described below, the thermoplastic elastomer is de-crosslinked at a temperature of about 80 to 200° C. resulting in an improved foamability, while it is crosslinked at a temperature of not higher than 80° C. to result in an improved tensile strength. In addition, while the dynamically crosslinked thermoplastic elastomer which includes a rubber (crosslinked rubber) suffers from the problem of the loss of surface smoothness and gloss after foaming, the foam (composition) of the present invention does not suffer from such problem due to the absence of the crosslinked rubber.

In the foam composition of the present invention, the content of the blowing agent (D) added to the thermoplastic elastomer (A) is preferably 0.01 to 10% by weight, more preferably 0.1 to 10% by weight, still more preferably 0.5 to 5% by weight, and most preferably 1 to 3% by weight in relation to the total weight of the foam composition. When the content of the blowing agent is within such range, the resulting foam of the present invention will exhibit favorable hardness and density as well as improved resistance to compression set.

The foam composition of the present invention may preferably contain a styrene thermoplastic elastomer in view of improving the compression set, and a filler in view of improving the reinforcing effect and the workability.

Next, the styrene thermoplastic elastomer and the filler which may be optionally included in the foam composition of the present invention are described in detail.

<Styrene Thermoplastic Elastomer>

The styrene thermoplastic elastomer which may be optionally incorporated in the foam composition of the present invention is a known styrene thermoplastic elastomer obtained as a block copolymer from an aromatic vinyl compound and a conjugated diene.

In view of improving the resistance to compression set, the styrene thermoplastic elastomer used in the present invention is preferably the one having at its terminal a site block-polymerized by aromatic vinyl which corresponds to a crosslink site and a weight average molecular weight of at least 100,000.

Exemplary such aromatic vinyl compounds include styrene, α-methylstyrene, 3-methylstyrene, and 4-propylstyrene, which may be used alone or in combination of two or more.

Exemplary conjugated dienes include butadiene, isoprene, and mixtures thereof.

When such styrene thermoplastic elastomer is incorporated, the resulting foam composition will have an improved resistance to compression set. This is presumably because the styrene thermoplastic elastomer which is incompatible and poorly flowable forms an independent phase, and the styrene thermoplastic elastomer which has high affinity with oil is incorporated in the crosslink structure of the thermoplastic elastomer (A) as the styrene thermoplastic elastomer has absorbed the oil.

In the present invention, the production method used in producing the styrene thermoplastic elastomer is not particularly limited. However, an exemplary preferable method is the production in which the polymer (block (A)) obtained by polymerizing the aromatic vinyl compound is copolymerized with the polymer (block (B)) obtained by polymerizing the conjugated diene.

The block (A) may preferably have a number average molecular weight in the range of 3,000 to 50,000. When the molecular weight is within such range, the resulting styrene thermoplastic elastomer will exhibit an improved mechanical strength, and the foam composition of the present invention produced by using the styrene thermoplastic elastomer will have a high resistance to compression set.

The block (B) may preferably have a number average molecular weight in the range of 10,000 to 200,000. When the molecular weight is within such range, the viscosity during the melt mixing in the course of obtaining the foam composition of the present invention by using the resulting styrene thermoplastic elastomer will be favorable, and hence, the viscosity during the melt mixing of the foam composition of the present invention will also be favorable.

The styrene thermoplastic elastomer obtained as a block copolymer has at least one block (A) and at least one block (B), and the form of the block may be represented by A-(B-A)ₙ or (A-B)ₘ. Of these forms, the preferred is A-B-A in view of the favorable flowability and mechanical properties, and also acceptable is the combination of A-B and A-B-A.

In the present invention, the styrene thermoplastic elastomer is preferably the one having a styrene content of 10 to 60% by weight, and more preferably 30 to 50% by weight. When the styrene content is within such range, the viscosity during the melt mixing in the course of obtaining the foam composition of the present invention will be favorable, and the resulting foam composition of the present invention will exhibit improved mechanical strength and resistance to compression set.

Exemplary styrene thermoplastic elastomers include hydrogenated styrene-isoprene block copolymer (SEPS: styrene ethylene propylene styrene block copolymer), styrene ethylene ethylene propylene styrene block copolymer (hereinafter referred to as “SEEPS”), and styrene ethylene butylene styrene block copolymer (hereinafter referred to as “SEBS”).

In the present invention, exemplary such styrene thermoplastic elastomers include commercially available products such as SEPTON 2006 (SEPS, manufactured by Kuraray Co., Ltd.) and SEPTON 4055 (SEEPS, manufactured by Kuraray Co., Ltd.).

In the foam composition of the present invention, the content of the styrene thermoplastic elastomer is preferably 1 to 500 parts by weight, more preferably 30 to 200 parts by weight, and most preferably 50 to 150 parts by weight in relation to 100 parts by weight of the thermoplastic elastomer (A). When the content of the styrene thermoplastic elastomer is within such range, the resulting foam composition of the present invention will exhibit improved mechanical strength and resistance to compression set.

<Filler>

The filler optionally incorporated in the foam composition of the present invention preferably contains carbon black and/or silica. The type of the carbon black may be adequately selected depending on the application of the composition. Carbon black is generally divided into hard carbon and soft carbon depending on the diameter of the particle. The soft carbon has low reinforcing effect on the rubber whereas the hard carbon has high reinforcing effect on the rubber. In the present invention, use of a hard carbon having a high reinforcing effect is preferable.

The content of the carbon black (when the carbon black is used alone) is preferably 1 to 200 parts by weight, more preferably 10 to 100 parts by weight, and most preferably 20 to 80 parts by weight in relation to 100 parts by weight of the thermoplastic elastomer (A).

The silica used is not particularly limited, and exemplary silicas include fumed silica, calcined silica, precipitated silica, pulverized silica, molten silica, and diatomaceous earth. The content (when silica is used alone) is 1 to 200 parts by weight, preferably 10 to 100 parts by weight, and most preferably 20 to 80 parts by weight in relation to 100 parts by weight of the thermoplastic elastomer (A). Among these, the preferred is precipitated silica.

When the filler used is silica, it may be used with a silane coupling agent. Exemplary silane coupling agents include bis(triethoxysilylpropyl) tetrasulfide (Si69), bis(triethoxysilylpropyl) disulfide (Si75), γ-mercaptopropyltrimethoxysilane, and vinyltrimethoxysilane. The aminosilane compound as will be described below may also be used.

When carbon black and silica are both used, the content (total amount of the carbon black and silica) is preferably 1 to 200 parts by weight, and more preferably 10 to 100 parts by weight, and most preferably 20 to 80 parts by weight in relation to 100 parts by weight of the thermoplastic elastomer (A).

The fillers other than the carbon black and the silica which may be used in the composition of the present invention include iron oxide, zinc oxide, aluminum oxide, titanium oxide, barium oxide, magnesium oxide, calcium carbonate, magnesium carbonate, zinc carbonate, talc clay, kaolin clay, and calcined clay. The content of such reinforcing agent is preferably 10 to 100 parts by weight, and more preferably 20 to 80 parts by weight in relation to 100 parts by weight of the thermoplastic elastomer (A).

The filler optionally used in the foam composition of the present invention is preferably a filler having amino group introduced therein (hereinafter simply referred to as “amino group-introduced filler”).

Examples of the filler used as the base of the amino group-introduced filler (hereinafter sometimes simply referred to as “base filler”) include silicas such as fumed silica, calcined silica, precipitated silica, pulverized silica, molten silica, and diatomaceous earth; carbon black, iron oxide, zinc oxide, titanium oxide, barium oxide, magnesium oxide, calcium carbonate, magnesium carbonate, zinc carbonate, talc clay, kaolin clay, and calcined clay, and the preferred are silica, carbon black, and calcium carbonate, and the more preferred is silica in view of the ease of amino group introduction and ease of adjusting the rate (proportion) of introduction.

The amino group introduced in the base filler (hereinafter sometimes simply referred to as “amino group”) is not particularly limited, and exemplary such amino groups include an aliphatic amino group, an aromatic amino group, an amino group constituting a heterocycle, and a mixture of such amino groups.

In the present invention, an amino group included in an aliphatic amine compound is referred to as an aliphatic amino group; an amino group attached to an aromatic group included in an aromatic amine compound is referred to as an aromatic amino group; and an amino group included in a heterocyclic amine compound is referred to as a heterocyclic amino group.

Among these, the preferred are a heterocyclic amino group, a mixture of amino groups containing the heterocyclic amino group, and an aliphatic amino group, and the more preferred are a heterocyclic amino group and an aliphatic amino group in view of appropriate degree of the interaction with the thermoplastic elastomer (A), and hence, effective dispersion in the thermoplastic elastomer.

The amino group is not particularly limited for its degree of substitution, and it may be any of the primary (—NH₂), secondary (imino group, >NH), tertiary (>N—), and quarternary (>N⁺<) amino groups.

However, when the amino group is primary amino group, interaction with the thermoplastic elastomer (A) tends to be enhanced, and gelation may take place depending on the conditions employed in the production of the composition. In the meanwhile, when the amino group is tertiary amino group, interaction with the thermoplastic elastomer (A) tends to be weakened, and the resulting foam composition may have insufficient improvement in the resistance to compression set.

In view of the situation as described above, the amino group is preferably a primary or a secondary amino group, and more preferably, a secondary amino group.

Accordingly, the amino group is preferably a heterocyclic amino group, a mixture of amino groups containing a heterocyclic amino group, or a primary or secondary aliphatic amino group, and more preferably, a heterocyclic amino group or a primary or secondary aliphatic amino group.

The base filler may have at least one amino group on its surface. However, the filler may preferably have two or more amino groups in view of greater improvement in resistance to compression set of the resulting foam composition.

When two or more amino groups are present, at least one of the two or more amino groups is preferably a heterocyclic amino group, and more preferably, the filler may also have a primary or a secondary amino group (aliphatic amino group, aromatic amino group, or heterocyclic amino group).

The type and the degree of substitution of the amino group may be adequately selected depending on the physical properties required for the composition.

The amino group-introduced filler is obtained by introducing the amino group in the base filler.

The method used in introducing the amino group is not particularly limited, and exemplary methods include surface treatments (for example, surface modification and surface coating) commonly used in various fillers, reinforcing agents, and the like. Preferable methods include the method in which a compound which has a functional group capable of reacting with the base filler and an amino group is reacted with the filler (surface modification), the method in which the surface of the base filler is coated with a polymer having an amino group (surface coating), and a method in which a compound having an amino group is reacted in the course of synthesizing the filler.

The amino group-introduced fillers may be used either alone or in combination of two or more. When two or more amino group-introduced fillers are used in combination, they may be mixed at any ratio depending on the application of the foam (composition) of the present invention and the physical properties and other factors required for the foam (composition) of the present invention.

The content of the amino group-introduced filler is preferably 1 to 200 parts by weight, and more preferably at least 10 parts by weight, and most preferably at least 30 parts by weight in relation to 100 parts by weight of the thermoplastic elastomer (A).

If necessary, the foam composition of the present invention may contain a polymer other than the thermoplastic elastomer (A) and the thermoplastic polymer (B), an amino group-containing compound other than the amino group-introduced filler, a compound containing a metal element (hereinafter simply referred to as “metal salt”), a maleic anhydride-modified polymer, an antiaging agent, an antioxidant, a pigment (dye), a plasticizer, a thixotropic agent, a UV absorbent, a flame retardant, a solvent, a surfactant (including a leveling agent), a dispersant, a dehydrating agent, an anticorrosive, a tackifier, an antistatic agent, and a filler, and other additives as long as the merit of the present invention is not adversely affected.

The additives used may be those commonly used in the art, and non-limiting exemplary such additives are as described below.

The polymer other than the thermoplastic elastomer (A) and the thermoplastic polymer (B) is preferably the one having a glass transition temperature of not higher than 25° C. for the same reason as described above. Exemplary such polymers include natural rubber (NR), isoprene rubber (IR), butadiene rubber (BR), 1,2-butadiene rubber, styrene-butadiene rubber (SBR), acrylonitrile-butadiene rubber (NBR), butyl rubber (IIR), ethylene-propylene-diene rubber (EPDM), ethylene-propylene rubber (EPM), ethylene-acrylic rubber (AEM), ethylene-butene rubber (EBM), optionally hydrogenated polystyrene elastomeric polymer (for example, SBS, SIS, and SEBS), polyolefin elastomeric polymer, polyvinyl chloride elastomeric polymer, polyurethane elastomeric polymer, polyester elastomeric polymer, and polyamide elastomeric polymer, and the preferred are a polymer such as IIR, EPM, or EBM containing no unsaturated bond or a polymer containing few unsaturated bonds (for example, EPDM). Also preferred are polymers having a site capable of forming hydrogen bond, for example, a polyester, a polylactone, and a polyamide.

The foam composition of the present invention may contain one or more polymers other than the thermoplastic elastomer (A), and the content of such polymer is preferably 0.1 to 100 parts by weight, and more preferably 1 to 50 parts by weight in relation to 100 parts by weight of the thermoplastic elastomer (A).

Next, the amino group-containing compound other than the amino group-introduced filler is described.

The amino group in the amino group-containing compound is basically the same as the one described for the amino group-introduced filler, and the number of amino groups in the compound is not particularly limited as long as at least one amino group is present. However, the amino group-containing compound may preferably contain two or more amino groups in view of forming two or more crosslinks with the thermoplastic elastomer (A) to thereby improve physical properties.

The amino group in the amino group-containing compound is not particularly limited for its degree of substitution, and it may be any of the primary (—NH₂), secondary (imino group, >NH), tertiary (>N—), and quarternary (>N⁺<) amino groups as in the case of the amino group in the amino group-introduced filler, and the amino group may be adequately selected depending on the recyclability and physical properties such as resistance to compression set, mechanical strength, and hardness required for the foam (composition) of the present invention. When a secondary amino group is selected, the resulting foam (composition) tends to have high mechanical strength, whereas selection of a tertiary amino group tends to result in a high recyclability. In particular, when two secondary amino groups are present, the resulting foam (composition) of the present invention will have excellent and well-balanced recyclability and resistance to compression set.

When the amino group-containing compound contains two or more amino groups, the number of primary amino groups in the amino group-containing compound is preferably not greater than two, and more preferably, not greater than one. When three or more primary amino groups are present, the crosslink (bond) formed by such amino groups and a functional group in the thermoplastic elastomer (A) (in particular carboxy group which is a carbonyl-containing group) may be excessively firm to detract from the excellent recyclability.

In other words, the degree of substitution of the amino group, the number of amino groups, and the structure of the amino group-containing compound may be adequately adjusted and selected by considering the bond strength between the functional group in the thermoplastic elastomer (A) and the amino group in the amino group-containing compound.

Exemplary preferable amino group-containing compounds include secondary aliphatic diamines such as N,N′-dimethylethylenediamine, N,N′-diethylethylenediamine, N,N′-diisopropylethylenediamine, N,N′-dimethyl-1,3-propanediamine, N,N′-diethyl-1,3-propanediamine, N,N′-diisopropyl-1,3-propanediamine, N,N′-dimethyl-1,6-hexanediamine, N,N′-diethyl-1,6-hexanediamine, and N,N′,N″-trimethylbis(hexamethylene)triamine; tertiary aliphatic diamines such as tetramethyl-1,6-hexanediamine; polyamines containing an aromatic primary amine and a heterocyclic amine such as aminotriazole and aminopyridine; straight chain alkylmonoamines such as dodecylamine; and tertiary heterocyclic diamines such as dipyridyl in view of the remarkable improvement in the resistance to compression set, mechanical strength, and the like.

Among these, the preferred are secondary aliphatic diamines, polyamines containing an aromatic primary amine and a heterocyclic amine, and tertiary heterocyclic diamines.

In addition to those mentioned above, an amino group-containing polymer compound may be used for the amino group-containing compound.

The amino group-containing polymer compound is not particularly limited, and examples include polymers such as polyamide, polyurethane, urea resin, melamine resin, polyvinylamine, polyallylamine, polyacrylamide, polymethacrylamide, polyaminostyrene, and amino group-containing polysiloxane, as well as polymers obtained by modifying various polymers with an amino group-containing compound.

These polymers are not particularly limited for their average molecular weight, molecular weight distribution, viscosity, and other physical properties, and they may have any desired physical properties depending on the application of the foam (composition) of the present invention and the physical properties and other factors required for the foam (composition) of the present invention.

The amino group-containing polymer compound is preferably a polymer produced by polymerizing (through polyaddition or polycondensation) an amino group-containing, condensable or polymerizable compound (monomer). More preferably, the amino group-containing polymer compound is an amino group-containing polysiloxane which is either a homocondensate of a silyl compound having a hydrolyzable substituent and the amino group or a co-condensate of such silyl compound with a silyl compound having no amino group, in view of ease of availability and production, and ease of adjustment of the molecular weight and adjustment of the rate of amino groups introduced.

The silyl compound having a hydrolyzable substituent and the amino group is not particularly limited, and exemplary compounds are aminosilane compounds which include aminosilane compounds having an aliphatic primary amino group such as γ-aminopropyltrimethoxysilane, γ-aminopropyltriethoxysilane, γ-aminopropylmethyldimethoxysilane, γ-aminopropylmethyldiethoxysilane, and 4-amino-3,3-dimethylbutyltrimethoxysilane (these compounds being manufactured by Nippon Unicar Co., Ltd.); aminosilane compounds having an aliphatic secondary amino group such as N,N-bis[(3-trimethoxysilyl)propyl]amine, N,N-bis[(3-triethoxysilyl)propyl]amine, N,N-bis[(3-tripropoxysilyl)propyl]amine (these compounds being manufactured by Nippon Unicar Co., Ltd.), 3-(n-butylamino)propyltrimethoxysilane (Dynasilane 1189 manufactured by Degussa-Huls), and N-ethyl-aminoisobutyltrimethoxysilane (Silquest A-Link 15 silane manufactured by OSi Specialties); aminosilane compounds having an aliphatic primary and an aliphatic secondary amino group such as N-β(aminoethyl)γ-aminopropylmethyldimethoxysilane, N-β(aminoethyl)γ-aminopropyltrimethoxysilane, and N-β(aminoethyl)γ-aminopropyltriethoxysilane (manufactured by Nippon Unicar Co., Ltd.); aminosilane compounds having an aromatic secondary amino group such as N-phenyl-γ-aminopropyltrimethoxysilane (manufactured by Nippon Unicar Co., Ltd.); and aminosilane compounds having a heterocyclic amino group such as imidazoletrimethoxysilane (manufactured by Japan Energy Corporation) and triazolesilane produced by reacting aminotriazole with an epoxysilane compound, an isocyanate silane compound, or the like in the presence or absence of a catalyst at a temperature not lower than the room temperature.

Among these, aminoalkylsilane compounds such as aminosilane compounds having an aliphatic primary amino group, aminosilane compounds having an aliphatic secondary amino group, and aminosilane compounds having an aliphatic primary and an aliphatic secondary amino group are preferable in view of their high effectivity in improving the resistance to compression set and other physical properties.

The silyl compound having no amino group is not particularly limited as long as it is a compound which is different from the silyl compound having a hydrolyzable substituent and the amino group and which contains no amino group. Examples thereof include alkoxysilane compounds and halogenated silane compounds. Among these, alkoxysilane compounds are preferable in view of their availability, ease of handling, and excellent physical properties of the resulting co-condensate.

Exemplary alkoxysilane compounds include tetramethoxysilane, tetraethoxysilane, tetrabutoxysilane, tetraisopropoxysilane, methyltrimethoxysilane, methyltriethoxysilane, methyltributoxysilane, methyltriisopropoxysilane, phenyltrimethoxysilane, and dimethyldimethoxysilane.

Exemplary halogenated silane compounds include tetrachlorosilane and vinyltrifluorosilane.

Among these, the preferred are tetraethoxy silane and tetramethoxy silane in view of the low price and safe handling.

The silyl compounds having a hydrolyzable substituent and the amino group and the silyl compounds having no amino group may be used either alone or in combination of two or more.

Such amino group-containing polymer compounds may be used either alone or in combination of two or more. When two or more such amino group-containing polymer compounds are used in combination, their mixing ratio may be adequately selected depending on the application of the foam (composition) of the present invention and the physical properties and other factors required for the foam (composition) of the present invention.

The content of the amino group-containing polymer compound can be defined by the number (equivalent) of nitrogen atoms in the compound with respect to the side chain of the thermoplastic elastomer (A) as in the amino group-containing compound. However, there may exist some amino groups incapable of effectively undergoing interaction with the thermoplastic elastomer (A) depending on the structure, molecular weight, and the like of the polymer compound.

Accordingly, the content of the amino group-containing polymer compound is preferably 1 to 200 parts by weight, more preferably at least 5 parts by weight, and most preferably at least 10 parts by weight in relation to 100 parts by weight of the thermoplastic elastomer (A).

The metal salt is not particularly limited as long as it is a compound containing at least one metal element, and the metal salt is preferably a compound containing at least one metal element selected from the group consisting of Li, Na, K, Ti, V, Cr, Mn, Fe, Co, Ni, Cu, Zn, Ga, and Al.

Examples of the metal salt include a salt of a C₁-C₂₀ saturated fatty acid such as formate, acetate, and stearate of at least one of the above-mentioned metal elements; a salt of an unsaturated fatty acid such as (meth)acrylate; a metal alkoxide (a reaction product with an alcohol containing 1 to 12 carbon atoms); a nitrate, a carbonate, a hydrogencarbonate, a chloride, an oxide, a hydroxide of such metal, and a complex with a diketone.

The “complex with a diketone” as used herein is a complex in which a 1,3-diketone (for example, acetyl acetone) or the like has coordinated with a metal atom.

Among these, the metal element is preferably Ti, Al, or Zn, and the metal salt is preferably a salt of a saturated fatty acid containing 1 to 20 carbon atoms such as acetate or stearate, a metal alkoxide (a reaction product with an alcohol containing 1 to 12 carbon atoms), an oxide, a hydroxide, and a complex with a diketone, and more preferably a salt of a saturated fatty acid containing 1 to 20 carbon atoms such as stearate, a metal alkoxide (a reaction product with an alcohol containing 1 to 12 carbon atoms), and a complex with a diketone, in view of greater improvement in the resistance to compression set of the resulting foam (composition) of the present invention.

The metal salts may be used either alone or in combination of two or more. When two or more metals are used in combination, they may be used at any ratio depending on the application of the foam (composition) of the present invention and the physical properties and other factors required for the foam (composition) of the present invention.

The content of such metal salt is preferably 0.05 to 3.0 equivalents, more preferably 0.1 to 2.0 equivalents, and most preferably 0.2 to 1.0 equivalents in relation to the carbonyl group in the thermoplastic elastomer (A). When the content of the metal salt is within such range, the resulting foam (composition) of the present invention will exhibit improved physical properties such as resistance to compression set, mechanical strength, and hardness.

The metal salt used may be in any possible form of the metal including the hydroxide, metal alkoxide, carboxylate, and the like. For example, when the salt is a hydroxide and the metal is iron, Fe(OH)₂ and Fe(OH)₃ may be used either alone or as a mixture.

In addition, while the metal salt is preferably a compound containing at least one metal element selected from the group consisting of Li, Na, K, Ti, V, Cr, Mn, Fe, Co, Ni, Cu, Zn, Ga, and Al, other metal elements may also be included in an amount that does not adversely affect the merits of the present invention. Although the content of the metal element other than the above-mentioned metal elements is not particularly limited, such metal element is preferably incorporated in an amount of 1 to 50% by mole in relation to all metal elements in the metal salt.

The maleic anhydride-modified polymer is a polymer produced by modifying the elastomeric polymer as described above with maleic anhydride. Although the side chain of the maleic anhydride-modified polymer may contain a functional group other than the maleic anhydride residue and the nitrogen-containing heterocycle, the side chain preferably contains only the maleic anhydride residue.

The maleic anhydride residue is not introduced in the main chain of the elastomeric polymer but is introduced (for modification) in the side chain or at the terminal of the elastomeric polymer. In addition, the maleic anhydride residue is a cyclic acid anhydride group, and this cyclic acid anhydride group (moiety) will not undergo ring opening.

Accordingly, an example of the maleic anhydride-modified thermoplastic polymer is a thermoplastic elastomer having no nitrogen-containing heterocycle but a cyclic acid anhydride group in the side chain as shown in the formula (41):

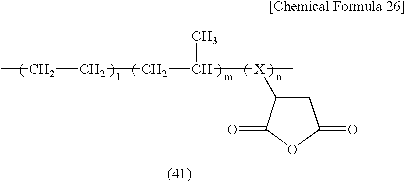

wherein X is ethylene residue or propylene residue; and l, m, and n are independently a number in the range of 0.1 to 80. Specific examples of such elastomeric polymer are those described for the elastomeric polymer having a cyclic acid anhydride group in the side chain.

The degree of modification with maleic anhydride is preferably 0.1 to 50% by mole, more preferably 0.3 to 30% by mole, and most preferably 0.5 to 10% by mole in relation to 100% by mole of the main chain moiety of the elastomeric polymer in view of the ability of improving the resistance to compression set without adversely affecting the excellent recyclability.

The maleic anhydride-modified polymers may be used either alone or in combination of two or more. When two or more maleic anhydride-modified polymers are used in combination, their mixing ratio may be adequately selected depending on the application of the (foam) composition of the present invention, and the physical properties and other factors required for the foam (composition) of the present invention.

The content of such maleic anhydride-modified polymer is preferably 1 to 100 parts by weight, and more preferably 5 to 50 parts by weight in relation to 100 parts by weight of the thermoplastic elastomer (A). When the content of the maleic anhydride-modified polymer is within such range, the resulting foam (composition) of the present invention will exhibit improved workability and mechanical strength.

In the production of the thermoplastic elastomer (A) of the present invention, and in particular, in the reaction step A or B, when an elastomeric polymer having a side chain containing a cyclic acid anhydride group remains unreacted, the remaining elastomer modified with the carbonyl-containing group may not be removed but be included as such in the foam (composition) of the present invention.

Examples of the antiaging agent include hindered phenol compounds and aliphatic and aromatic hindered amine compounds.

Examples of the antioxidant include butylhydroxytoluene (BHT), and butylhydroxyanisole (BHA).

Examples of the pigment include inorganic pigments such as titanium dioxide, zinc oxide, ultramarine, iron red, lithopone, lead, cadmium, iron, cobalt, aluminum, hydrochloride, and sulfate; organic pigments such as azo pigment and copper phthalocyanine pigment.

Examples of the plasticizer include derivatives of benzoic acid, phthalic acid, trimellitic acid, pyromellitic acid, adipic acid, sebacic acid, fumaric acid, maleic acid, itaconic acid, and citric acid; polyester plasticizers; polyether plasticizers; and epoxy plasticizers.

Examples of the thixotropic agent include bentonite, silicic anhydride, silicic acid derivatives, and urea derivatives.

Examples of the UV absorbent include 2-hydroxybenzophenone UV absorbents, benzotriazole UV absorbents, and salicylic acid ester UV absorbents.

Examples of the flame retardant include phosphorus flame retardants such as TCP; halogen flame retardants such as chlorinated paraffin and perchloropentacyclodecane; antimony flame retardants such as antimony oxide; and aluminum hydroxide, and magnesium hydroxide.

Examples of the solvent include hydrocarbons such as hexane and toluene; halogenated hydrocarbons such as tetrachloromethane; ketones such as acetone and methyl ethyl ketone; ethers such as diethylether and tetrahydrofuran; and esters such as ethyl acetate.

Examples of the surfactant (leveling agent) include polybutyl acrylate, polydimethylsiloxane, modified silicone compounds, and fluorosurfactants.

An example of the dehydrating agent includes vinylsilane.

Examples of the anticorrosive include various anticorrosive pigments such as zinc phosphate, tannic acid derivatives, phosphoric acid esters, and basic sulfonates.

Examples of the tackifier include known silane coupling agents, silane compounds containing an alkoxysilyl group, titanium coupling agents, and zirconium coupling agents, and more specifically, trimethoxyvinylsilane, vinyltriethoxysilane, vinyl tris(2-methoxyethoxy)silane, γ-methacryloxypropyltrimethoxysilane, and 3-glycidoxypropyltrimethoxysilane.

Examples of the antistatic agent generally include quaternary ammonium salts, and hydrophilic compounds such as polyglycols and ethylene oxide derivatives.

The content of the plasticizer is preferably 0.1 to 100 parts by weight, more preferably 1 to 80 parts by weight, still more preferably 1 to 50 parts by weight, and most preferably 1 to 30 parts by weight in relation to 100 parts by weight of the thermoplastic elastomer (A). The content of other additives is preferably in the range of 0.1 to 50 parts by weight, more preferably 1 to 30 parts by weight, still more preferably 1 to 10 parts by weight, and most preferably 1 to 5 parts by weight in relation to 100 parts by weight of the thermoplastic elastomer (A).

While some of the thermoplastic elastomers (A) are self-crosslinkable, the thermoplastic elastomers (A) may be used in combination with a vulcanizing agent, a vulcanization aid, a vulcanization accelerator, a vulcanization retarder, or the like as long as the object of the present invention is not impaired.

Examples of the vulcanizing agent include sulfur vulcanizing agents, organic peroxide vulcanizing agents, metal oxide vulcanizing agents, phenol resin vulcanizing agents, and quinone dioxime vulcanizing agents.

Exemplary sulfur vulcanizing agents include powdered sulfur, precipitated sulfur, highly dispersible sulfur, surface treated sulfur, insoluble sulfur, dimorpholine disulfide, and alkyl phenol disulfides.

Exemplary organic peroxide vulcanizing agents include benzoyl peroxide, t-butyl hydroperoxide, 2,4-dichlorobenzoyl peroxide, 2,5-dimethyl-2,5-di(t-butylperoxy)hexane, and 2,5-dimethylhexane-2,5-di(peroxyl benzoate).

Other vulcanizing agents include magnesium oxide, litharge (lead oxide), p-quinone dioxime, tetrachloro-p-benzoquinone, p-dibenzoylquinone dioxime, poly-p-dinitrosobenzene, and methylenedianiline.

Examples of the vulcanization aid include zinc oxide, magnesium oxide, amines; fatty acids such as acetyl acid, propionic acid, butanoic acid, stearic acid, acrylic acid, and maleic acid; zinc salts of fatty acids such as zinc acetylate, zinc propionate, zinc butanoate, zinc stearate, zinc acrylate, and zinc maleate.

Examples of the vulcanization accelerator include thiuram vulcanization accelerators such as tetramethylthiuram disulfide (TMTD) and tetraethylthiuram disulfide (TETD); aldehyde ammonia vulcanization accelerators such as hexamethylenetetramine; guanidine vulcanization accelerators such as diphenylguanidine; thiazole vulcanization accelerators such as 2-mercaptobenzothiazole and dibenzothiazyl disulfide (DM); and sulfenamide vulcanization accelerators such as N-cyclohexyl-2-benzothiazylsulfenamide and N-t-butyl-2-benzothiazylsulfenamide. An alkylphenol resin or its halide may also be employed.

Examples of the vulcanization retarder include organic acids such as phthalic anhydride, benzoic acid, salicylic acid, and acetylsalicylic acid; nitroso compounds such as N-nitroso-diphenylamine, N-nitroso-phenyl-p-naphthylamine, and a polymer of N-nitroso-trimethyl-dihydroquinoline; halides such as trichloromelanine; 2-mercaptobenzimidazole; and N-(cyclohexylthio)phthalimide (SANTOGARD PVI).

The content of such vulcanizing agent is preferably 0.1 to 20 parts by weight and more preferably 1 to 10 parts by weight in relation to 100 parts by weight of the thermoplastic elastomer (A).

The vulcanization conditions used when the foam composition of the present invention is permanently crosslinked (by using a vulcanizing agent) are not particularly limited, and an adequate set of conditions may be selected depending on the components incorporated in the composition, and the like. A preferable vulcanization condition is carrying out vulcanization at a temperature of 130 to 200° C. for 5 to 60 minutes.

When the foam composition of the present invention is heated to a temperature of about 80 to 200° C., the three-dimensional crosslink (crosslink structure) will become dissociated and the foam composition will gain some softness and fluidity presumably because of weakening of the intermolecular or intramolecular interaction between the side chains.

When the foam composition of the present invention that has become softer and more fluid is left to stand at a temperature of about 80° C. or lower, the dissociated three-dimensional crosslink (crosslink structure) will regain its crosslink to become vulcanized. The recyclability of the foam composition of the present invention is realized by the repetition of such steps.

Such foam composition of the present invention is preferably capable of being kneaded at a temperature not higher than 180° C. Such capability of being kneaded at a temperature not higher than 180° C. is preferable since conventional known blowing agents (in particular, organic chemical blowing agents) are designed to cause foaming at a temperature in excess of 180° C. When the blowing agent incorporated is the one which causes foaming at a temperature not higher than 180° C., the composition should be kneaded at a temperature not higher than such foaming temperature.

The method used in producing the foam (composition) of the present invention is not particularly limited, and exemplary methods include a method in which the thermoplastic elastomer (A) and the blowing agent with optional additives are kneaded in a roll mill, a kneader, a single screw extruder, a twin screw extruder, a universal blender, or the like, and the kneaded mixture is heated to a temperature equal to or higher than the foaming temperature of the blowing agent (for example, by hot pressing); and a method in which the ingredients are mixed in a single screw extruder, a twin screw extruder or the like and foamed simultaneously with the extrusion.

As described more specifically in the Examples, the composition is kneaded at a temperature of 160 to 180° C. for several minutes, and hot-pressed in a mold at about 200° C. for a few minutes to a few tens of minutes, and then cold-pressed to lower to room temperature. In particular, the foam composition containing the thermoplastic polymer (B) and the internal release agent (C) according to the second aspect of the present invention is foamed simultaneously with the extrusion by increasing the resin pressure immediately before the die of the extruder feeder, for example, to a pressure of at least 5 MPa as will be described in the Examples.

The foam (composition) of the present invention has excellent foamability, and as a consequence, the resulting product has low hardness as well as low density. The foam (composition) of the present invention also exhibits improved resistance to compression set owing to the use of the thermoplastic elastomer (A), and because of such favorable properties, it is adapted for use as a material for a cap or packing.

### EXAMPLES

Next, the present invention is described in further detail by referring to the Examples, which by no means limit the scope of the present invention.

### Example 1

First, 100 g of maleic anhydride-modified ethylene-propylene copolymer (TX-1215, manufactured by Mitsui Chemicals, Inc., hereinafter abbreviated as “maleinized EPM1”) (maleic anhydride skeleton, 10.2 mmol) and 100 g of ethylene-propylene copolymer (TAFMER P(0180), manufactured by Mitsui Chemicals, Inc., hereinafter abbreviated as “EPM1”) were incorporated in a kneader set at 180° C., and the masticated for 4 minutes. Next, 0.64 g of N-n-octylaminoethanol (NYMEEN C-201 manufactured by NOF CORPORATION) was added, and the mixture was kneaded for 7 minutes. Then, 0.72 g of 4H-3-amino-1,2,4-triazole (ATA, manufactured by Nippon Carbide Industries Co., Inc.) was added, and the mixture was kneaded for 5 minutes. The content (rubber) was removed from the kneader, and again placed in the kneader for kneading for 5 minutes to thereby produce thermoplastic elastomer 1.

Next, 2 g of azodicarbonamide (AZ VI-8, manufactured by Otsuka Chemical Co., Ltd.) was added to the kneader, and kneaded with the thermoplastic elastomer 1 at 160° C. for 5 minutes to produce thermoplastic elastomer composition 1.

The thus prepared thermoplastic elastomer composition 1 was placed in a mold with a foaming rate of 1.5, and subjected to hot pressing at 200° C. for 10 minutes, and then cold pressing (pressing with cooling by a water jacket) for 7 minutes to thereby produce foam 1.

### Comparative Example 1

The thermoplastic elastomer 1 prepared in Example 1 was hot-pressed at 200° C. for 10 minutes to produce pressed article 1.

### Comparative Example 2

The procedure of Example 1 was repeated by using 200 g of dynamically crosslinked thermoplastic elastomer (Santoprene 121-68W228 (foam grade), manufactured by Advanced Elastomer Systems Japan Ltd.) instead of the thermoplastic elastomer 1 to thereby produce foam 2.

<Specific Gravity>

The thus prepared pressed article 1, foam 1, and foam 2 were measured for their specific gravity (g/cm³). The results are shown below in Table 1.

<JIS-A Hardness>

Sample plates (thickness, 2 cm; length, 15 cm; width, 15 cm) were produced by using the pressed article 1, foam 1, and foam 2, respectively. For each type of the sample plate, 3 sample plates were placed on top of one another, and hot-pressed at 200° C. for 20 minutes. JIS-A hardness was measured in accordance with JIS K6253. The results are shown below in Table 1.

<Tensile Properties>

Sheets having a thickness of 2 mm were produced by using the pressed article 1, foam 1, and foam 2, respectively.

No. 3 dumbbell test pieces were blanked from the sheets, and tensile test was conducted according to JIS K6251 at a tensile speed of 500 mm/min to thereby measure 100% modulus (M₁₀₀) [MPa], breaking strength (T_{B}) [MPa], and elongation at break (E_{B}) [%] at room temperature. The results are shown below in Table 1.

<Foamability>

(1) State of Foamed Cells

Foamability was evaluated by visually confirming the state of the foamed cells in the foam 1 and foam 2. The results are shown below in Table 1.

(2) Surface of the Foam

Foamability was evaluated by visually confirming the state of the foam surface in the foam 1 and foam 2. The results are shown below in Table 1.

<Compression Set (C-Set)>

Sheets having a thickness of 2 mm were produced by using the pressed article 1, foam 1, and foam 2, respectively. For each type, 7 sheets were stuck on top of one another and hot-pressed at 200° C. for 20 minutes to produce a sample cylinder (diameter, 29 mm; thickness 12.5 mm).

This sample cylinder was compressed by 25% with a special jig and left to stand at 70° C. for 22 hours. The compression set was then measured according to JIS K6262.

TABLE 1

| | | Com- | |
|---|---|---|---|
| | | parative | Comparative |
| | Example 1 | Example 1 | Example 2 |
| Maleinized EPM1 | 100 | 100 | — |
| EPM1 | 100 | 100 | — |
| NYMEEN C-201 | 0.64 | 0.64 | — |
| ATA | 0.72 | 0.72 | — |
| Santoprene | — | — | 200 |
| Azodicarbonamide | 2 | 0 | 2 |
| Kneading time | 160° C., 5 min | — | 160° C., 5 min |
| Hot pressing | 200° C., 10 min | — | 200° C., 10 min |
| Cold pressing | 7 min | — | 7 min |
| Foaming rate | 1.5 | — | 1.5 |
| Specific gravity | 0.44 | 0.89 | 0.45 |
| (g/cm³) | | | |
| JIS-A hardness | 38 | 68 | 39 |
| Tensile properties | | | |
| M₁₀₀ (MPa) | 0.66 | 1.8 | 0.04 |
| T_{B} (MPa) | 0.97 | 3.2 | 0.04 |
| E_{B} (%) | 406 | 614 | 80 |
| Foamability | | | |
| State of the foamed | Uniform | — | Non-uniform |
| cells | | | |
| Foam surface | Good | — | Poor |
| Compression set (%) | 43 | 58 | 48 |

As demonstrated in Table 1, the foam obtained in Example 1 has favorably reduced specific gravity and hardness compared to the sample of Comparative Example 1 which does not contain the blowing agent. The results shown in Table 1 also demonstrated that the foam obtained in Example 1 is superior in all of tensile properties, foamability, and resistance to compression set compared to the foam of Comparative Example 2 prepared by using the dynamically crosslinked thermoplastic elastomer.

### Examples 2 to 7, and Reference Examples 1 and 2

The thermoplastic elastomer (A), the thermoplastic polymer (B), and the internal release agent (C), as well as the styrene thermoplastic elastomer, the filler, the paraffin oil, the phenol antiaging agent, the N-n-octylaminoethanol (NYMEEN C-201 manufactured by NOF CORPORATION), and the 4H-3-amino-1,2,4-triazole (ATA, manufactured by Nippon Carbide Industries Co., Inc.) were blended in the amounts in part by weight shown in Table 2 to prepare a thermoplastic elastomer composition, which was then placed in an extruder feeder (Model PEX-25-28; type, single screw; screw diameter, 25 mm; L/D, 28; die diameter, 1 mm; manufactured by Pla Giken Co., Ltd.) with the blowing agent (D) in the amount in % by weight shown in Table 2. The mixture was then extruded and foamed at the predetermined cylinder temperature (C1, 140° C.; C2, 160° C.; C3, 100° C.; C4, 100° C.; adaptor, 100° C.; die, 100° C.) and at the resin pressure before the die of the level shown in Table 2 to thereby produce the foam.

The MFR of the thermoplastic polymer (B) blended, the capillary viscosity of the thermoplastic elastomer composition, and the foam rate and outer appearance of the resulting foam were measured by the procedures as described below. The results are shown in Table 2.

<MFR (Melt Mass-Flow Rate)>

The MFR of the thermoplastic polymer (B) was measured at 230° C. under the load of 2.16 kg according to the procedure defined in JIS K 7210: 1999, “Plastics—Testing method for melt mass-flow rate (MFR) of thermoplastics”.

<Capillary Viscosity>

The capillary viscosity of the thermoplastic elastomer composition was measured at 20° C. and at a shear rate of 60.8 s⁻¹ according to the procedure defined in JIS K 7199: 1999, “Plastics-Testing method of flow characteristics of plastics using capillary rheometers”.

<Foam Rate of the Foam>

The specific gravity of the foam produced by the extrusion foaming was measured before and after the foaming and subjected to comparative calculation to determine its foam rate.

<Outer Appearance of the Foam>

The outer appearance of the foam produced by the extrusion foaming was determined by visual inspection and touching of the outer surface. The sample with the surface of rough texture was rated “poor”, and the one with slightly rough texture was rated “fair”. The one with no rough feeling was rated “good”, and the one with shiny surface was rated “excellent”. The foam with the evaluation no worse than “fair” is acceptable for its practical use.

TABLE 2

| | MFR | Reference | Example | Reference | Example | Example | Example | Example | Example |
|---|---|---|---|---|---|---|---|---|---|
| | (g/10 min) | Example 1 | 2 | Example 2 | 3 | 4 | 5 | 6 | 7 |
| Thermoplastic elastomer (A1) | | 100 | 100 | 100 | 100 | 100 | 100 | 100 | 100 |
| Thermoplastic polymer (B1) | 0.6 | 100 | 100 | | | | | | |
| Thermoplastic polymer (B2) | 10 | | | 100 | 100 | | 100 | 100 | 100 |
| Thermoplastic polymer (B3) | 40 | | | | | 100 | | | |
| Internal release agent (C1) | | | 5 | | 5 | 5 | 5 | 5 | 5 |
| Styrene thermoplastic elastomer | | 50 | 50 | 50 | 50 | 50 | 50 | 50 | 50 |
| Filler | | 20 | 20 | 20 | 20 | 20 | 20 | 20 | 20 |
| Paraffin oil | | 100 | 100 | 100 | 100 | 100 | 100 | 100 | 100 |
| Phenol antiaging agent | | 1 | 1 | 1 | 1 | 1 | 1 | 1 | 1 |
| ATA | | 1.1 | 1.1 | 1.1 | 1.1 | 1.1 | 1.1 | 1.1 | 1.1 |
| NYMEEN C-201 | | 0.5 | 0.5 | 0.5 | 0.5 | 0.5 | 0.5 | 0.5 | 0.5 |
| Capillary viscosity (Pa · s) | | 10800 | 10000 | 7200 | 6800 | 2100 | 6800 | 6800 | 6800 |
| Blowing agent (% by weight) | | 1.3 | 1.3 | 1.3 | 1.3 | 1.3 | 1.3 | 2.6 | 5.3 |
| Resin pressure before the die (MPa) | | 4.2 | 11.7 | 4.5 | 9.5 | 6.9 | 3.1 | 10.7 | 11.2 |
| Foam ratio of the foam (fold) | | 1.2 | 2.0 | 1.3 | 2.5 | 1.8 | 1.4 | 3.1 | 3.5 |
| Outer appearance of the foam | | poor | excellent | poor | excellent | good | fair | excellent | excellent |

The components shown in Table 2, above, are as described below.
Thermoplastic elastomer (A1): maleinized EPM1
Thermoplastic polymer (B1): ethylene-propylene copolymer (TAFMER P0775, manufactured by Mitsui Chemicals, Inc.)
Thermoplastic polymer (B2): soft polyolefin resin (M142E, manufactured by Idemitsu Kosan Co., Ltd.)
Thermoplastic polymer (B3): ethylene-propylene copolymer (TAFMER P0080K, manufactured by Mitsui Chemicals, Inc.)
Internal release agent (C1): a mixture of fatty acid amide, fatty acid ester, and fatty acid metal salt (Struktol HT 204, manufactured by Schill Seilacher)
Styrene thermoplastic elastomer: SEPTON 4077 (SEEPS); styrene content, 30% by weight; manufactured by Kuraray Co., Ltd.
Filler: light calcium carbonate, manufactured by Maruo Calcium Co., Ltd.
Paraffin oil: PW-100, manufactured by Idemitsu Kosan Co., Ltd.
Phenol antiaging agent: pentaerythrityl-tetrakis[3-(3,5-di-t-butyl-4-hydroxyphenyl)propionate] (IRGANOX 1010, manufactured by Ciba Specialty Chemicals)
ATA: 4H-3-amino-1,2,4-triazole, manufactured by Nippon Carbide Industries Co., Inc.
NYMEEN C-201: N-n-octylaminoethanol, manufactured by NOF CORPORATION
Blowing agent: OBSH (NEOCELLBORN, manufactured by Eiwa Chemical Ind. Co., Ltd.)

As demonstrated in Table 2, the foams obtained by the extrusion foaming in Examples 2 to 7 were superior in the outer appearance and foam ratio compared to the foams obtained in Reference Examples 1 and 2 which do not contain the internal release agent (C). Comparison of the foam obtained in Example 5 with the foams of other Examples also demonstrated that increase in the resin pressure before the die of the extruder feeder results in the better outer appearance of the foam product.

### INDUSTRIAL APPLICABILITY

As described above, the present invention can provide a foam having reduced hardness and density, and an improved resistance to compression set, as well as a foam composition for producing such a foam, and is therefore useful.

1. A foam composition comprising: a thermoplastic elastomer (A) which has a side chain containing at least one member selected from the group consisting of imino group, nitrogen-containing heterocycle and covalent crosslink site, and a carbonyl-containing group; and
a blowing agent (D).

2. A foam composition comprising:
a thermoplastic elastomer composition comprising
a thermoplastic elastomer (A) which has a side chain containing at least one member selected from the group consisting of imino group, nitrogen-containing heterocycle and covalent crosslink site, and a carbonyl-containing group;
a thermoplastic polymer (B) and
an internal release agent (C); and
a blowing agent (D).

3. The foam composition according to claim 2 wherein the thermoplastic polymer (B) has an MFR (melt mass-flow rate) at least 0.01 g/10 min as measured at 230° C. under the load of 2.16 kg.

4. The foam composition according to claim 2 wherein content of the thermoplastic polymer (B) is 1 to 300 parts by weight in relation to 100 parts by weight of the thermoplastic elastomer (A).

5. The foam composition according to claim 2 wherein the thermoplastic elastomer (A) and the thermoplastic polymer (B) have a solubility parameter (Sp) value satisfying the formula:
$$0.9 < \frac{S p ( A )}{S p ( B )} < 1.1 \qquad [ Mathematical Formula 1 ]$$
wherein Sp(A) represents the solubility parameter of the thermoplastic elastomer (A) and Sp(B) represents the solubility parameter of the thermoplastic polymer (B).

6. The foam composition according to claim 2 wherein the internal release agent (C) is at least one member selected from the group consisting of fatty acid amide, fatty acid ester, fatty acid metal salt, and metallic compound.

7. The foam composition according to claim 2 wherein content of the internal release agent (C) is 0.1 to 50 parts by weight in relation to 100 parts by weight of the thermoplastic elastomer (A).

8. The foam composition according to claim 2 wherein the thermoplastic elastomer composition has a capillary viscosity of at least 3000 Pa·s as measured at 120° C. and at a shear rate 60.8 s⁻¹.

9. The foam composition according to claim 1 wherein the side chain of the thermoplastic elastomer (A) contains a structure represented by the following formula (1): 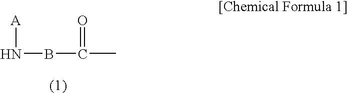
wherein A is an alkyl group containing 1 to 30 carbon atoms, an aralkyl group containing 7 to 20 carbon atoms, or an aryl group containing 6 to 20 carbon atoms; B is a single bond; oxygen atom, an amino group NR′ (wherein R′ is hydrogen atom or an alkyl group containing 1 to 10 carbon atoms), or sulfur atom; or an organic group which may contain such atom or group.

10. The foam composition according to claim 9 wherein the side chain containing the structure represented by the formula (1) contains a structure represented by the following formula (2) or (3) which binds to a main chain at α position or β position: 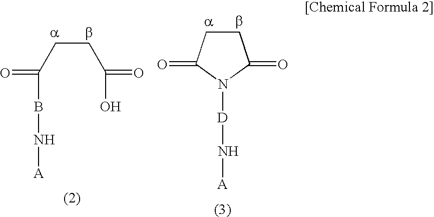
wherein A is an alkyl group containing 1 to 30 carbon atoms, an aralkyl group containing 7 to 20 carbon atoms, or an aryl group containing 6 to 20 carbon atoms, B and D are independently a single bond; oxygen atom, an amino group NR′ (wherein R′ is hydrogen atom or an alkyl group containing 1 to 10 carbon atoms), or sulfur atom; or an organic group which may contain such atom or group.

11. The foam composition according to claim 1 wherein the side chain of the thermoplastic elastomer (A) contains a structure represented by the following formula (4): 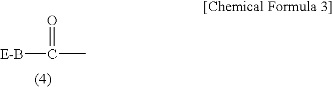
wherein E is a nitrogen-containing heterocycle, and B is a single bond; oxygen atom, an amino group NR′ (wherein R′ is hydrogen atom or an alkyl group containing 1 to 10 carbon atoms), or sulfur atom; or an organic group which may contain such atom or group.

12. The foam composition according to claim 11 wherein the side chain containing the structure represented by the formula (4) contains a structure represented by the following formula (5) or (6) which binds to a main chain at α position or β position: 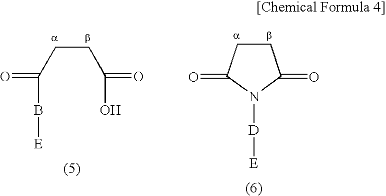
wherein E is a nitrogen-containing heterocycle, and B and D are independently a single bond; oxygen atom, an amino group NR′ (wherein R′ is hydrogen atom or an alkyl group containing 1 to 10 carbon atoms), or sulfur atom; or an organic group which may contain such atom or group.

13. The foam composition according to claim 1 wherein the nitrogen-containing heterocycle is a five-membered or a six-membered ring.

14. The foam composition according to claim 13 wherein the nitrogen-containing heterocycle is triazole ring, thiadiazole ring, pyridine ring, thiazole ring, imidazole ring, or hydantoin ring.

15. The foam composition according to claim 11 wherein the side chain containing the structure represented by the formula (4) contains a structure represented by the following formula (7), formula (8) or (9), or formula (10): 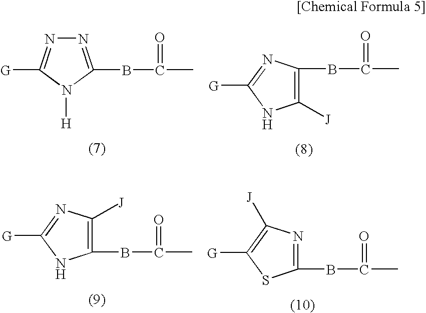
wherein B is a single bond; oxygen atom, an amino group NR′ (wherein R′ is hydrogen atom or an alkyl group containing 1 to 10 carbon atoms), or sulfur atom; or an organic group which may contain such atom or group, and G and J are independently hydrogen atom, an alkyl group containing 1 to 30 carbon atoms, an aralkyl group containing 7 to 20 carbon atoms, or an aryl group containing 6 to 20 carbon atoms.

16. The foam composition according to claim 15 wherein the side chain containing the structure represented by the formula (4) contains a structure which binds to a main chain at α position or β position and is represented by the following formula (11) or (12), any one of formulae (13) to (16), or formula (17) or (18): 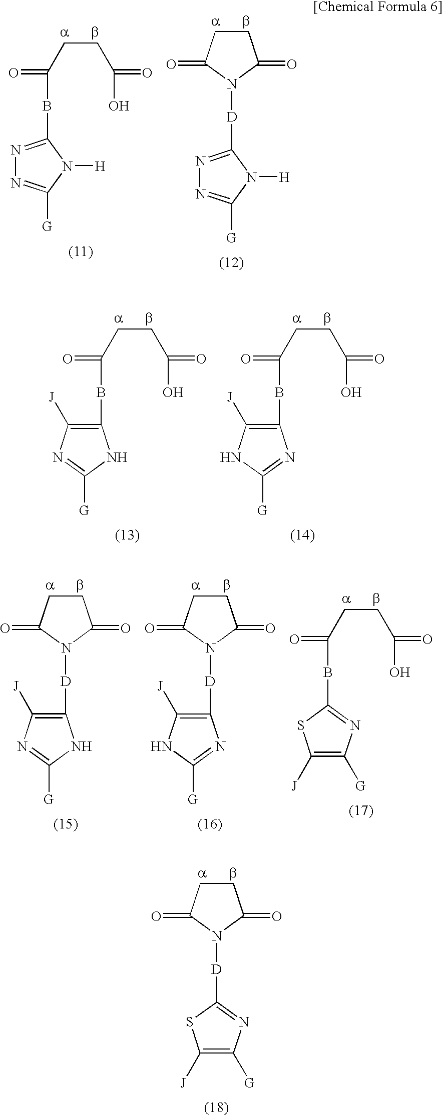
wherein B and D are independently a single bond; oxygen atom, an amino group NR′ (wherein R′ is hydrogen atom or an alkyl group containing 1 to 10 carbon atoms), or sulfur atom; or an organic group which may contain such atom or group, G and J are independently hydrogen atom, an alkyl group containing 1 to 30 carbon atoms, an aralkyl group containing 7 to 20 carbon atoms, or an aryl group containing 6 to 20 carbon atoms.

17. The foam composition according to claim 1 wherein crosslink at the covalent crosslink site can be realized by at least one bond selected from the group consisting of amide, ester, lactone, urethane, ether, thiourethane, and thioether.

18. The foam composition according to claim 1 wherein crosslink at the covalent crosslink site has been realized by at least one bond selected from the group consisting of amide, ester, lactone, urethane, ether, thiourethane, and thioether.

19. The foam composition according to claim 18 wherein the covalent crosslink site contains a tertiary amino group.

20. The foam composition according to claim 18 wherein the covalent crosslink site contains at least one structure represented by any one of the following formulae (19) to (21): 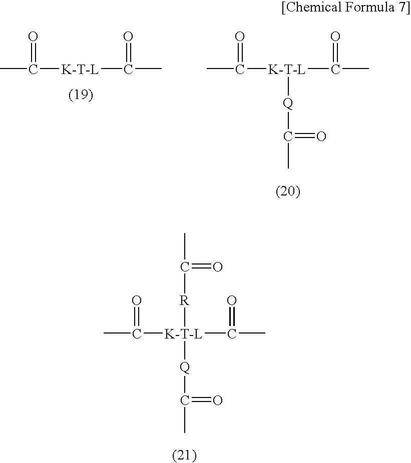
wherein K, L, Q, and R are independently a single bond; oxygen atom, an amino group NR′ (wherein R′ is hydrogen atom or an alkyl group containing 1 to 10 carbon atoms), or sulfur atom; or an organic group which may contain such atom or group, and T is an optionally branched hydrocarbon group which may contain oxygen atom, sulfur atom, or nitrogen atom.

21. The foam composition according to claim 20 wherein the covalent crosslink site contains at least one structure represented by any one of the following formulae (22) to (24) which binds to a main chain at α position or β position: 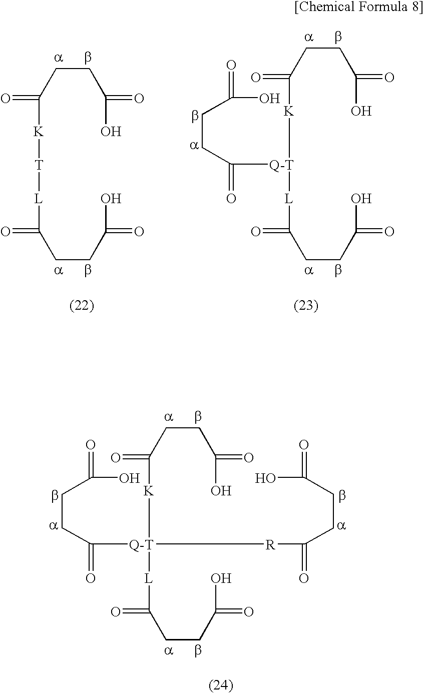
wherein K, L, Q, and R are independently a single bond; oxygen atom, an amino group NR′ (wherein R′ is hydrogen atom or an alkyl group containing 1 to 10 carbon atoms), or sulfur atom; or an organic group which may contain such atom or group, and T is an optionally branched hydrocarbon group which may contain oxygen atom, sulfur atom, or nitrogen atom.

22. The foam composition according to claim 20 wherein any T in the formulae (19) to (24) contains a tertiary amino group.

23. The foam composition according to claim 18 wherein the covalent crosslink site is formed by a reaction of a cyclic acid anhydride group with hydroxy group, an amino group and/or imino group.

24. The foam composition according to claim 1 wherein content of the foam is 0.01 to 10% by weight in relation to a total weight of the foam composition.

25. The foam composition according to claim 1 which is capable of being kneaded at a temperature of not higher than 180° C.

26. The foam composition according to claim 1 further comprising a styrene thermoplastic elastomer.

27. The foam composition according to claim 26 wherein content of the styrene thermoplastic elastomer is 1 to 500 parts by weight in relation to 100 parts by weight of the thermoplastic elastomer (A).

28. The foam composition according to claim 1 further comprising a filler.

29. The foam composition according to claim 28 wherein content of the filler is 1 to 200 parts by weight in relation to 100 parts by weight of the thermoplastic elastomer (A).

30. A foam obtained by blowing the foam composition according to claim 1.
